(19) United States
(12) Patent Application Publication
(10) Pub. No.: US 2016/0147420 A1
(43) Pub. Date: May 26, 2016

(54) AGED DATA CONTROL WITH IMPROVED INTERFACE

(71) Applicant: Microsoft Technology Licensing, LLC, Redmond, WA (US)

(72) Inventors: Michael F. Falkner, Fargo, ND (US); Kevin M. Honeyman, Fargo, ND (US); Paul R. Winje, West Fargo, ND (US); Matthew D. Leonard, Arlington, TX (US); Shivendushital Pyarelal Pandey, South Fargo, ND (US); Veronika Maksimova, Fargo, ND (US)

(21) Appl. No.: 14/549,165

(22) Filed: Nov. 20, 2014

(51) Int. Cl. G06F 3/0484

(52) U.S. Cl. CPC G06F 3/04847

(57) ABSTRACT

A time line display mechanism includes a control slider. The control slider is actuated to configure, in a computing system memory, an aging period definition. The computing system accesses relevant data and applies the aging period definition to the relevant data to generate a representation of the aged data with the aging period definition applied. The representation of the aged data is surfaced in the computing system, along with an aging display mechanism that represents the aging period definition. The aging display mechanism includes actuators that can be actuated to reconfigure the aging period in memory so that it can be reapplied to modify the displayed representation of the aged data.

### BACKGROUND

Computer systems are in wide use. Some such computer systems provide user interface displays that allow a user to interact with the computer system in order to configure the hardware portions of the computer system to surface data in a desired way.

As one example, some computer systems have a memory that stores transactions, and information or data relevant to those transactions, by date. This is sometimes referred to as aged data. It may be that one or more data assessors (e.g., a user, a group of users, or other computer system), access the aged data and perform further processing or other operations, processes, activities, or steps based upon the aged data.

In such examples, the different data assessors may wish to have the aged data surfaced from the computing system in different ways. Thus, the computing system sometimes provides an interface that the user can interact with in order to modify the particular format or configuration that is used to identify, aggregate, and surface the aged data for further interaction or processing. These types of interfaces have sometimes been in tabular form. The form often provided text boxes for text to be entered in defining the format or configuration for surfacing the aged data. It provided some buttons or other user interface elements that were actuated in order to further specify the format or configuration. This was relatively cumbersome, and tended to be error prone.

Mobile devices are also currently in wide use. Many mobile devices have display screens that are touch sensitive, and that have relatively limited display real estate, relative to desktop computers, for instance. Problems associated with interacting with a computer system in order to surface aged data is exacerbated on such small screen devices. For instance, where a user interacts with the computer system by entering text in text boxes, the relatively small display screens can increase the cumbersome nature of this interaction, and it can also increase error rate, thus reducing user efficiency, on small screen devices.

The discussion above is merely provided for general background information and is not intended to be used as an aid in determining the scope of the claimed subject matter.

### SUMMARY

A time line display mechanism includes a control slider. The control slider is actuated to configure, in a computing system memory, an aging period definition. The computing system accesses relevant data and applies the aging period definition to the relevant data to generate a representation of the aged data with the aging period definition applied. The representation of the aged data is surfaced in the computing system, along with an aging display mechanism that represents the aging period definition. The aging display mechanism includes actuators that can be actuated to reconfigure the aging period in memory so that it can be reapplied to modify the displayed representation of the aged data.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is block diagram of one example of a computing system architecture.

FIGS. 2-1 and 2-2 (collectively referred to as FIG. 2) show a flow diagram illustrating one example of the operation of an aging period configuration engine (shown in FIG. 1).

FIGS. 2A-2R show examples of user interface displays.

FIGS. 3A-3B (collectively referred to herein as FIG. 3) show a flow diagram illustrating one example of the operation of a runtime interaction engine (shown in FIG. 1).

FIGS. 3C-3D show examples of user interface displays.

FIG. 4 is a block diagram of one example of the architecture shown in FIG. 1, deployed in a cloud computing architecture.

FIGS. 5-7 show various examples of mobile devices.

FIG. 8 is a block diagram of one example of a computing environment that can be used in the architecture shown in FIGS. 1 and/or 4.

### DETAILED DESCRIPTION

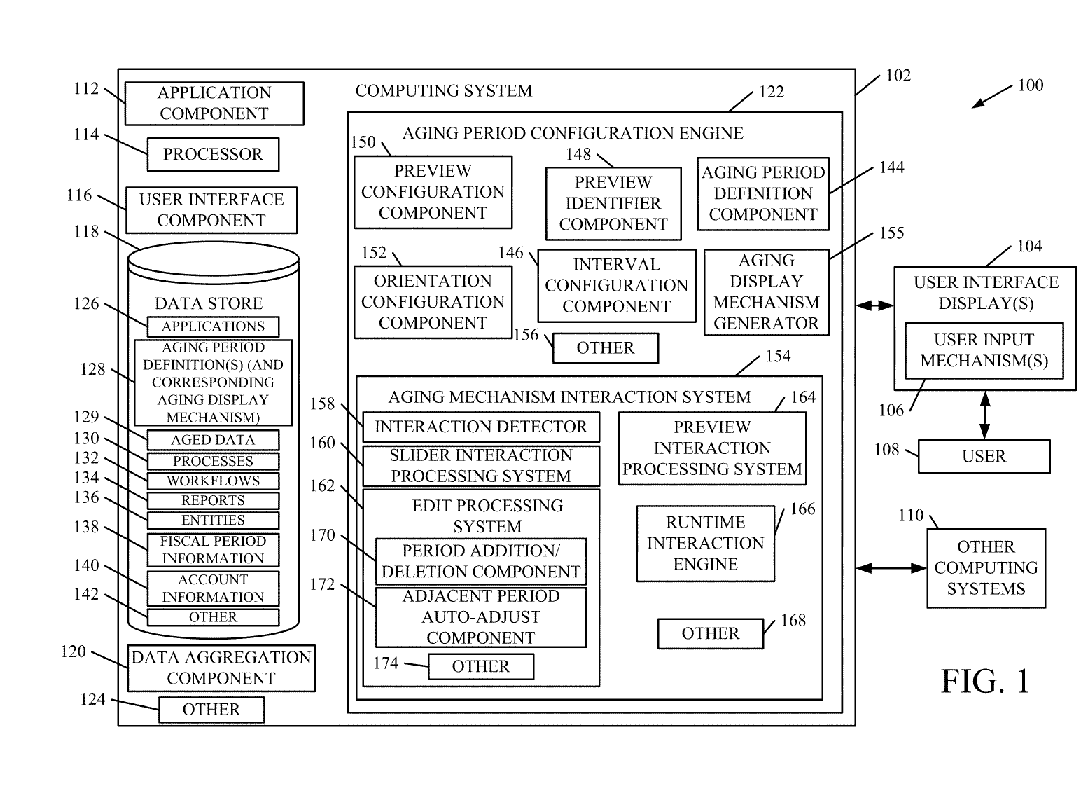

FIG. 1 is a block diagram of one example of a computing system architecture 100. Architecture 100 illustratively includes computing system 102 that generates user interface displays 104, with user input mechanisms 106 for interaction by one or more users 108. Computing system 102 can also interact with other computing systems 110. User 108 can illustratively interact with user input mechanisms 106 on user interface displays 104 (or using other user input modes) to control and manipulate computing system 102. Computing system 102, in turn, can provide information that can be displayed on user interface displays 104, and that can be provided to other computing systems 110 for further processing.

In the example shown in FIG. 1, computing system 102 illustratively includes application component 112, one or more processors or servers 114, user interface component 116, data store 118, data aggregation component 120, aging period configuration engine 122, and it can include other items 124 as well. Data store 118 can include one or more applications 126, aging period definitions (and corresponding aging display mechanisms) 128, aged data 129, processes 130, workflows 132, reports 134, entities 136, fiscal period information 138, account information 140, and other information 142.

Aging period configuration engine 122 illustratively includes aging period definition component 144, interval configuration component 146, preview identifier component 148, preview configuration component 150, orientation configuration component 152, aging mechanism interaction system 154, aging display mechanism generator 155, and it can include other items 156. Aging mechanism interaction system 154 illustratively includes interaction detector 158, slider interaction processing system 160, edit processing system 162, preview interaction processing system 164, runtime interaction engine 166, and it can include other items 168. Edit processing system 162, itself, illustratively includes period addition/deletion component 170, adjacent period auto-adjustment component 172 and it can include other items 174.

Before describing the operation of system 102 in more detail, a brief overview of some of the items in system 102, and their operation, will first be provided. In the present discussion, it will be noted that computing system 102 can be substantially any computing system in which a series of transactions, and corresponding data relevant to the transactions, are illustratively sorted by date, and then aggregated into groups, in series, based upon date. One example of aged data will be described in the context of computing system 102 being a business system. Business systems can include, for instance, customer relations management (CRM) systems, enterprise resource planning (ERP) systems, line-of-business (LOB) systems, among others. These types of systems can be implemented in various computing environments and they configure the hardware components of the computing environments to perform operations and processes that can be used in carrying out the business of an organization that uses the business system.

For example, applications 126, in the context of a business system, can be any of a wide variety of applications that can be used to configure a computing system to perform operations that are useful to the organization that uses the business system. Some examples of the applications include inventory tracking applications, general ledger applications, calendar and scheduling applications, electronic mail applications, among a wide variety of others. Application component 112 illustratively runs applications 126 which, themselves, can implement processes 130 and workflows 132. The applications 126 can also operate on entities, fiscal period information, account information, or other records 142. The entities illustratively represent items within the business system. For instance, a customer entity represents and defines a customer within the business system. A vendor entity represents and defines a vendor. An account entity represents and defines an account, etc. These are only examples of the various entities that can be used in a business system, and a wide variety of others can be used as well.

In one example, user 108 or other computing systems 110 illustratively wish to obtain aged data 129 from computing system 102 according to a given format or configuration. Aging period configuration engine 122 illustratively generates a user interface (such as a user interface display 104 or an interface to other computing systems 110), that has user input mechanisms that receive inputs that allow user 108 or other computing systems 110 to define an aging period definition which identifies the structure or format, or other configuration, with which computing system 102 will surface aged data 129. As the user interacts with the user input mechanisms, aging period configuration engine 122 illustratively generates the aging period definition 128 based on those inputs, and stores it in memory. Engine 122 also generates a representation of that definition that can be displayed or otherwise presented to user 108 or other computing systems 110, with input mechanisms that can be actuated to change the definition. When the inputs are received, engine 122 illustratively reconfigures the aging period definition 128, in memory, and also automatically adjusts the aging display mechanism that represents that definition, in memory. During runtime, runtime interaction engine 166 identifies the relevant aged data 129 that the aging period definition 128 is to be applied to. It retrieves that aged data 129 from memory and applies the aging period definition to it to generate a representation of the aged data 129 with the aging period definition 128 applied. This representation can be stored in memory or rendered to a display or otherwise output for interaction by user 108 or other computing systems 110.

In one example, computing system 102 not only surfaces the aged data in the format or configuration defined by the aging period definition, it also surfaces an aging display mechanism that represents the aging period definition. The aging display mechanism illustratively includes input mechanisms that can be actuated by user 108 or other computing systems 110 to modify the aging period definition, even during runtime. Runtime interaction engine 166 then illustratively detects that interaction and reconfigures the aging period definition 128 and generates a new aging display mechanism that represents the reconfigured aging period definition. It also illustratively invokes data aggregation component 120 to identify aged data 129 that is relevant to the reconfigured aging period definition and to aggregate the data into a format or other configuration based upon the reconfigured aging period definition 128. Runtime interaction engine 166 then generates an output representation of the aged data 129 that is retrieved from memory and has the aging period definition 128 applied to it.

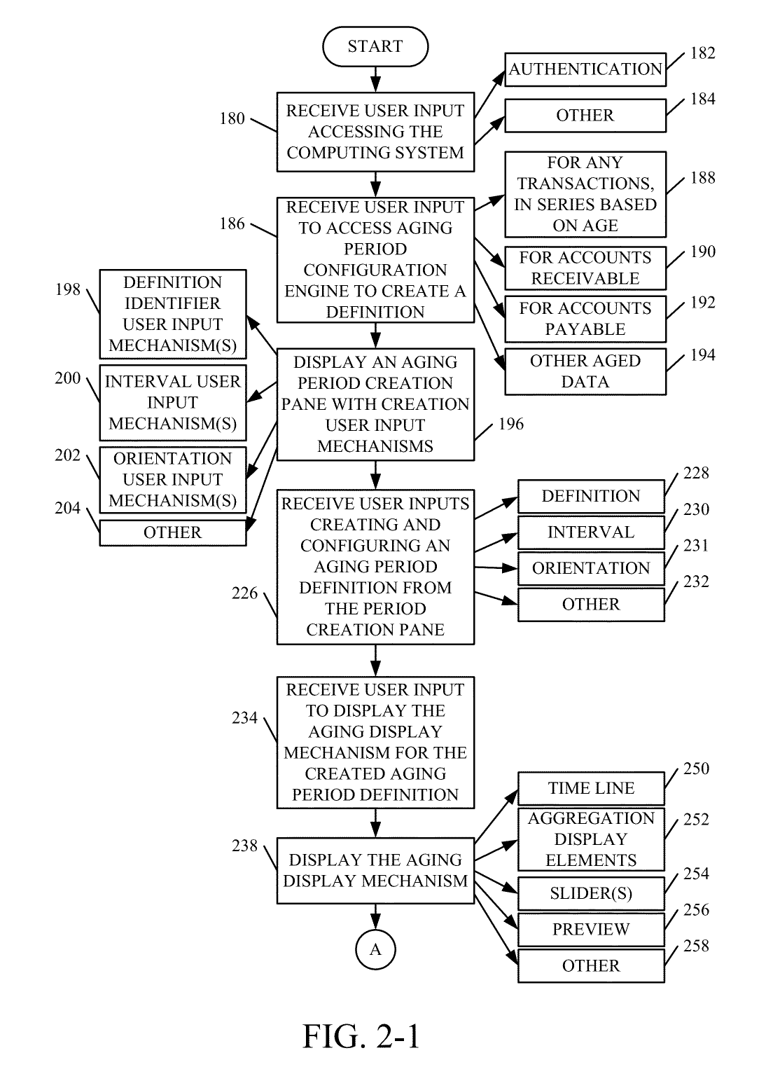

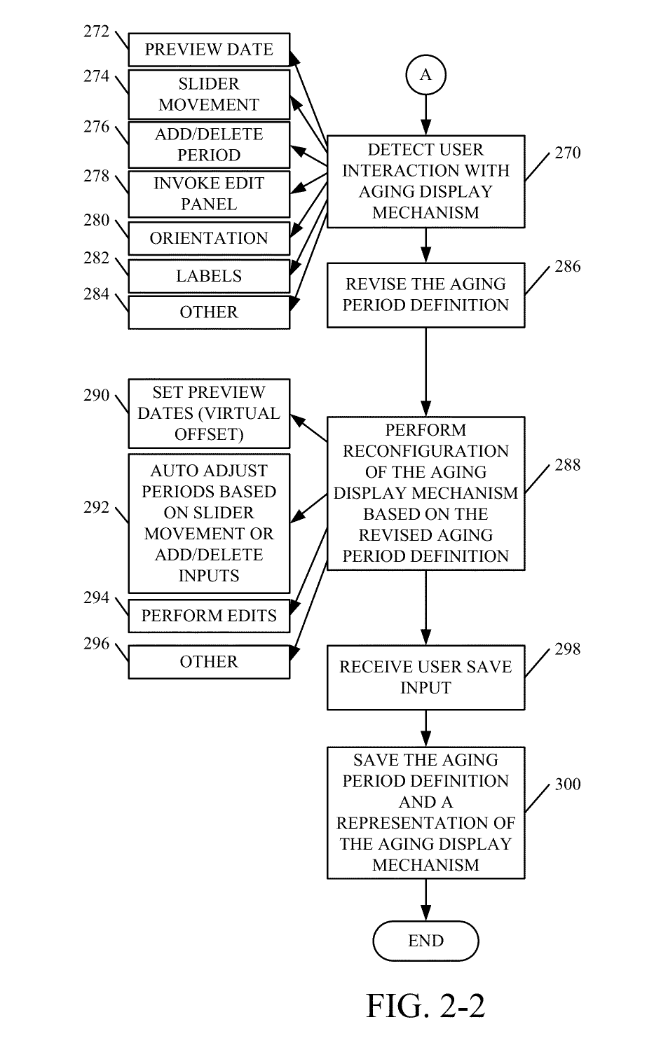

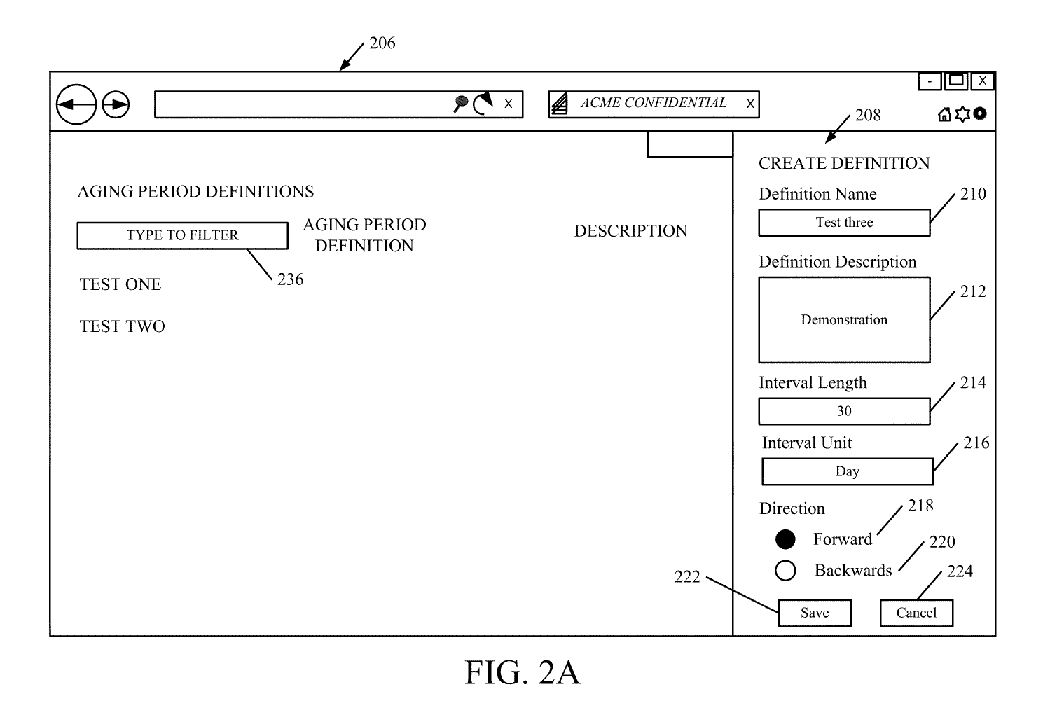

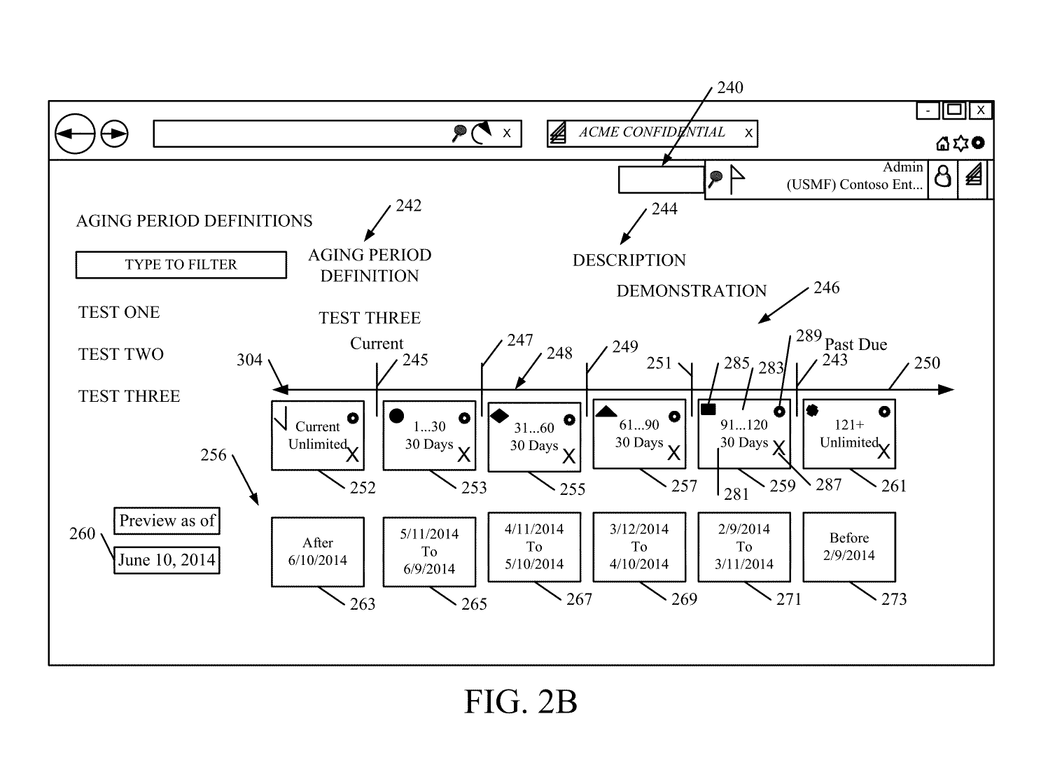

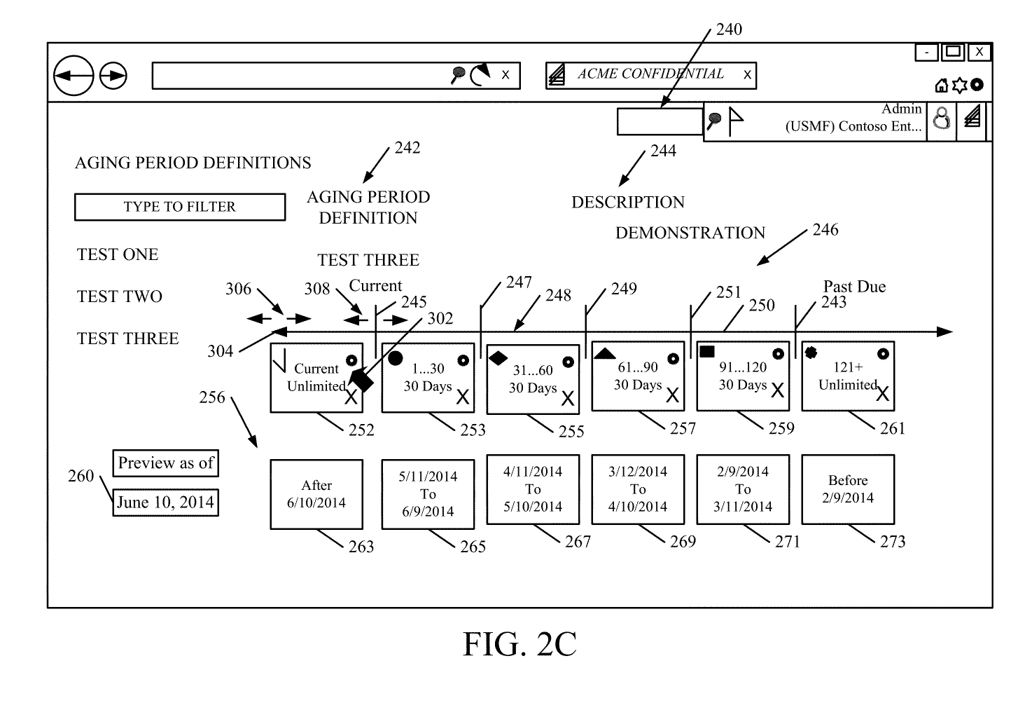

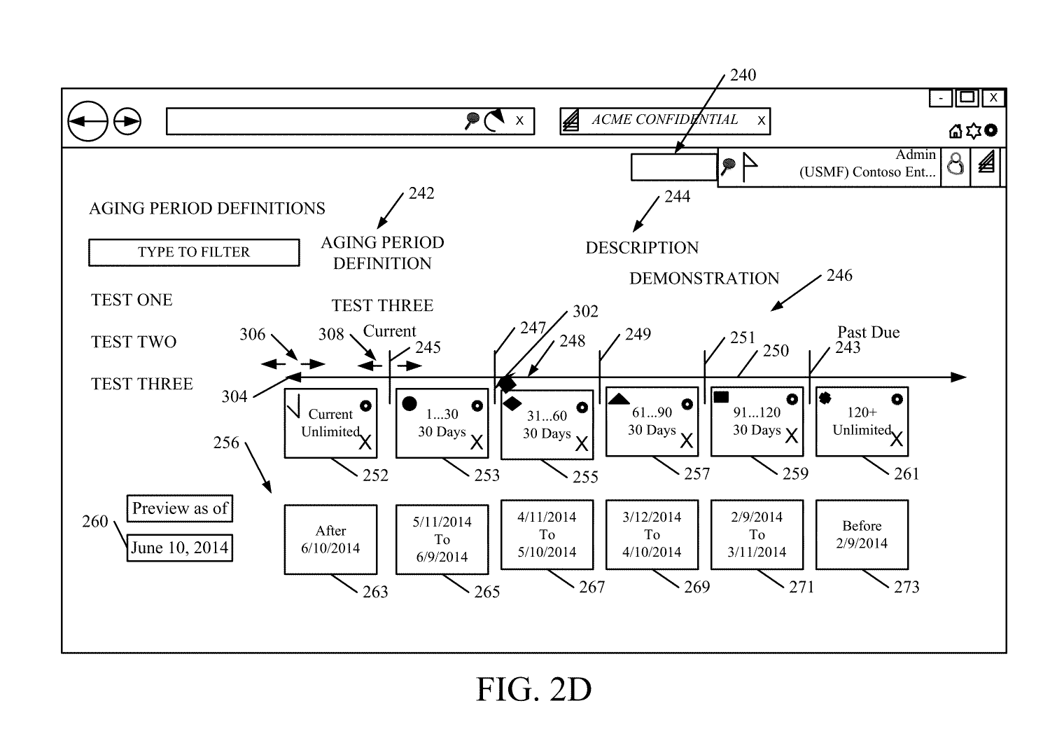

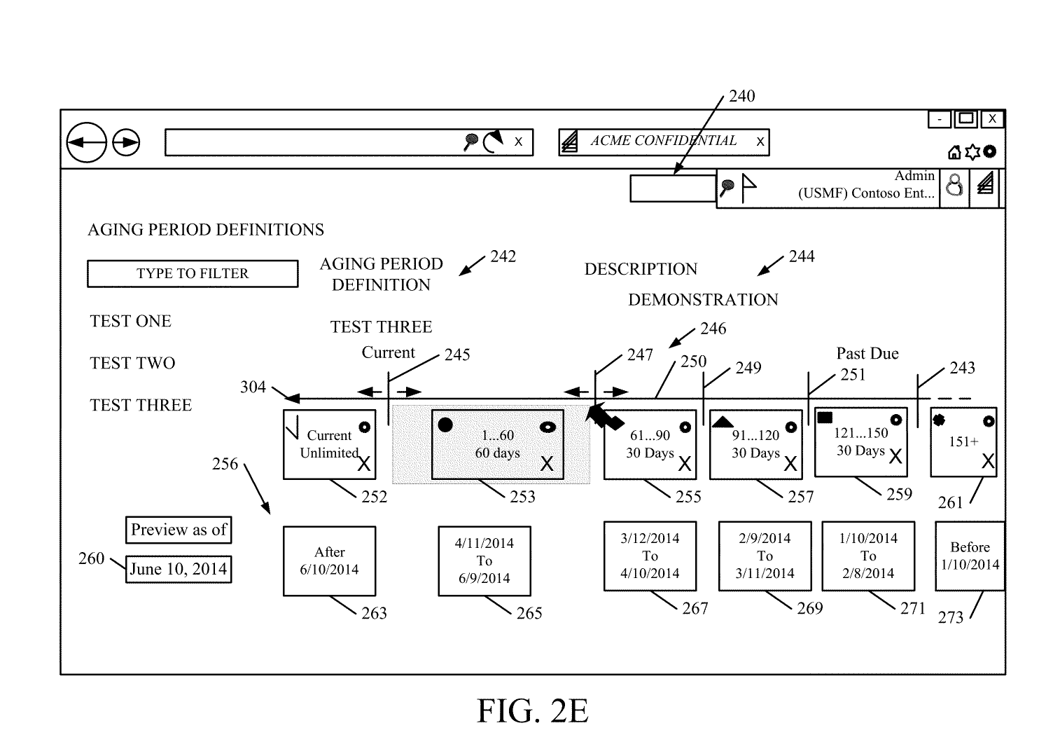

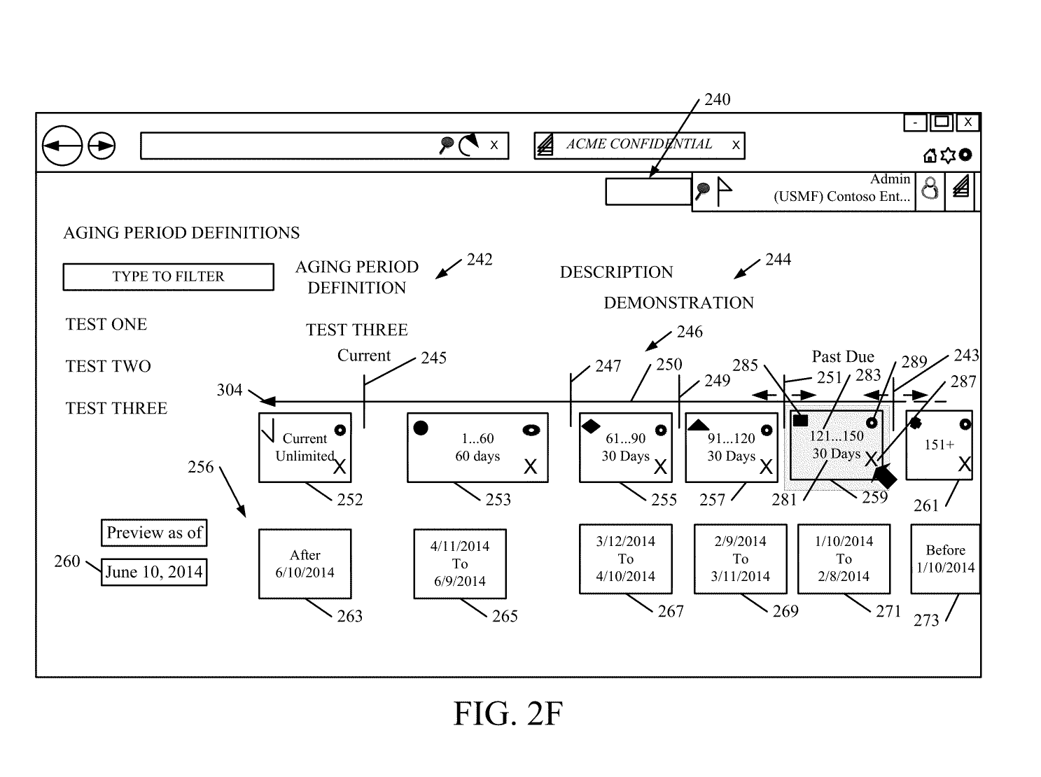

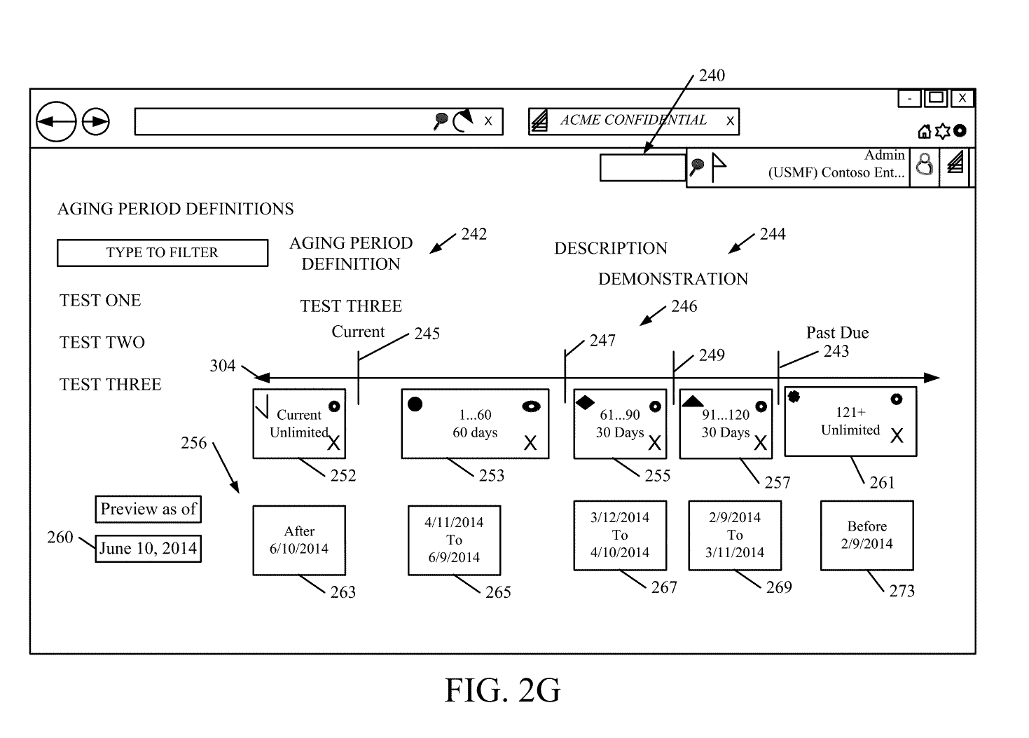

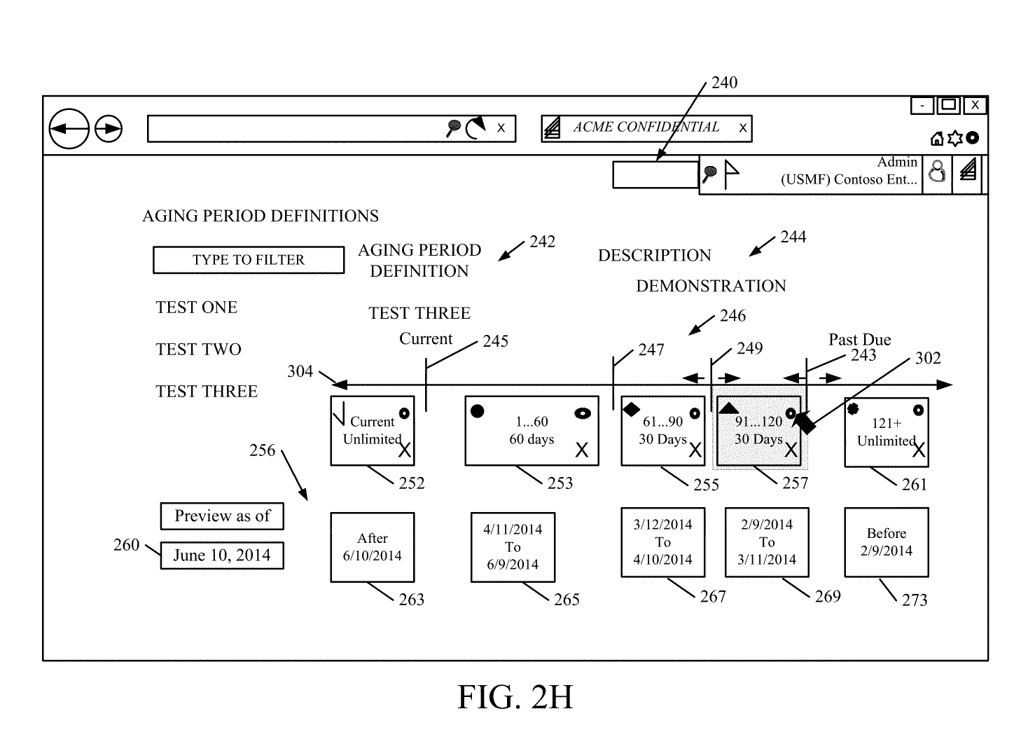

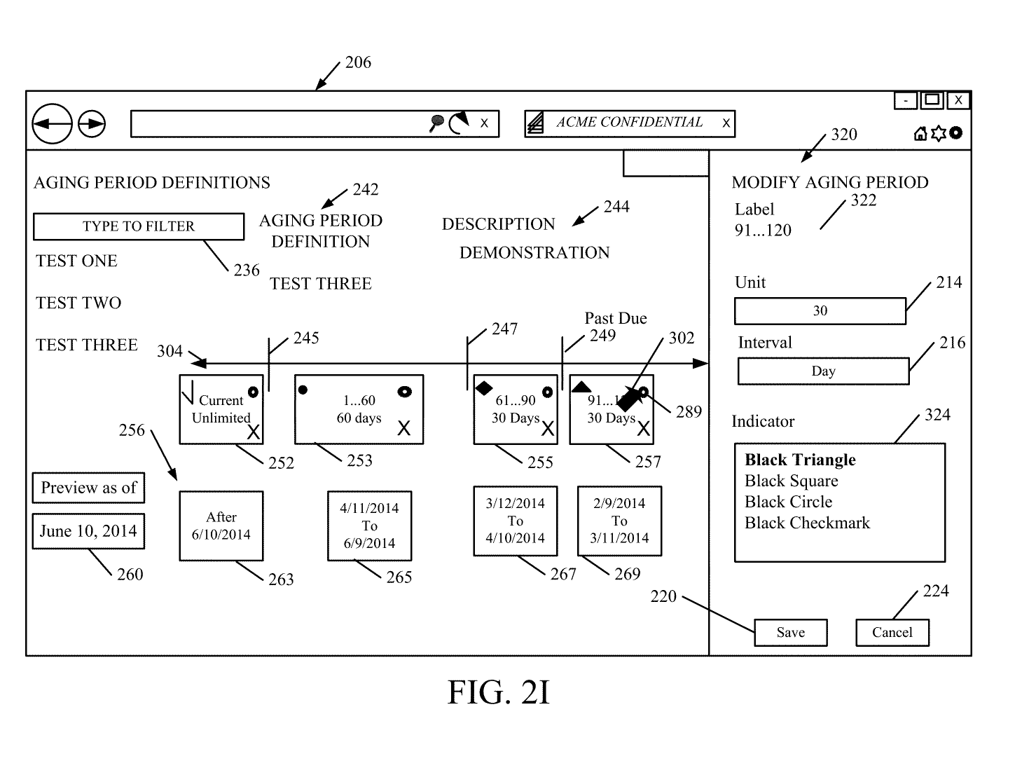

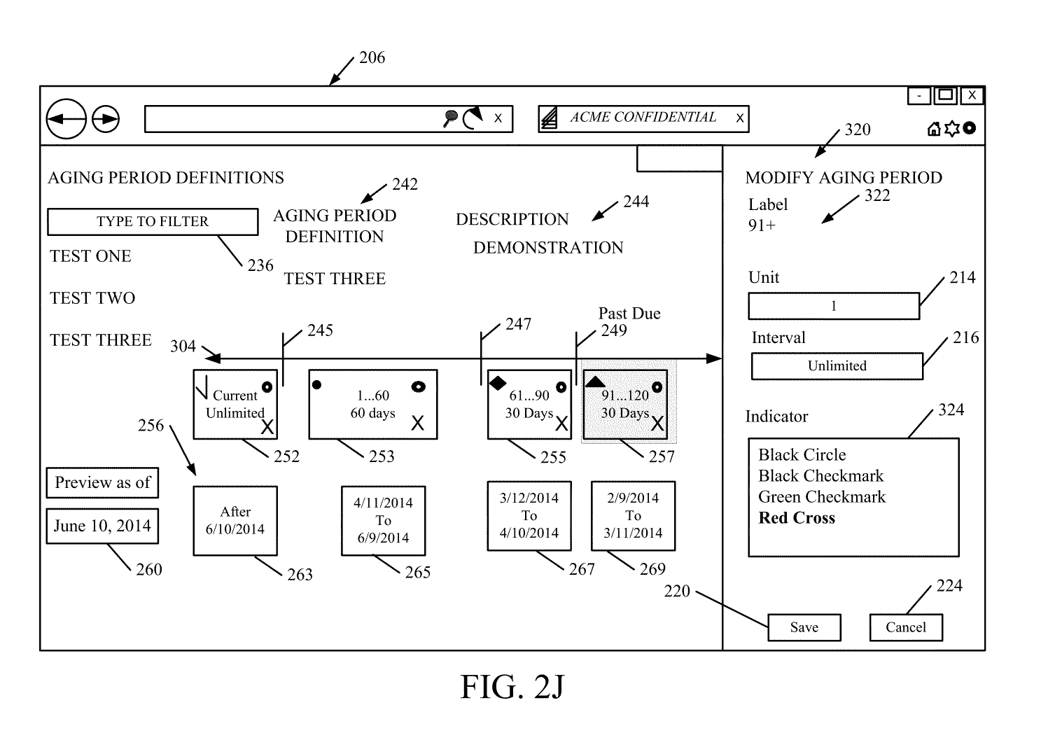

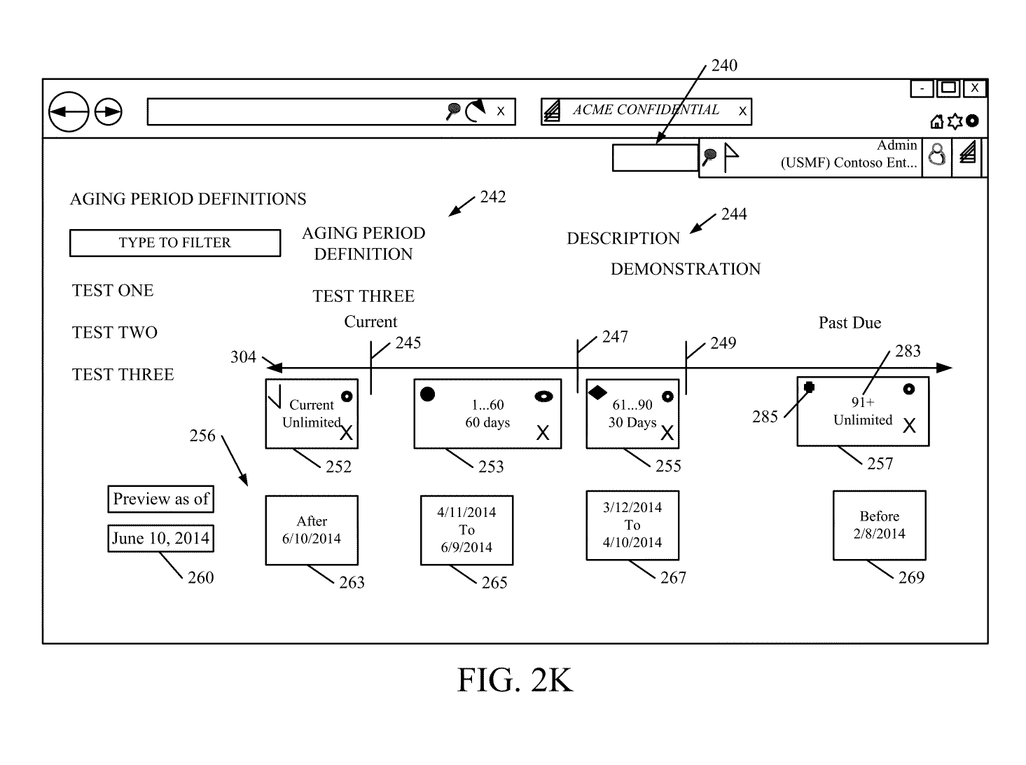

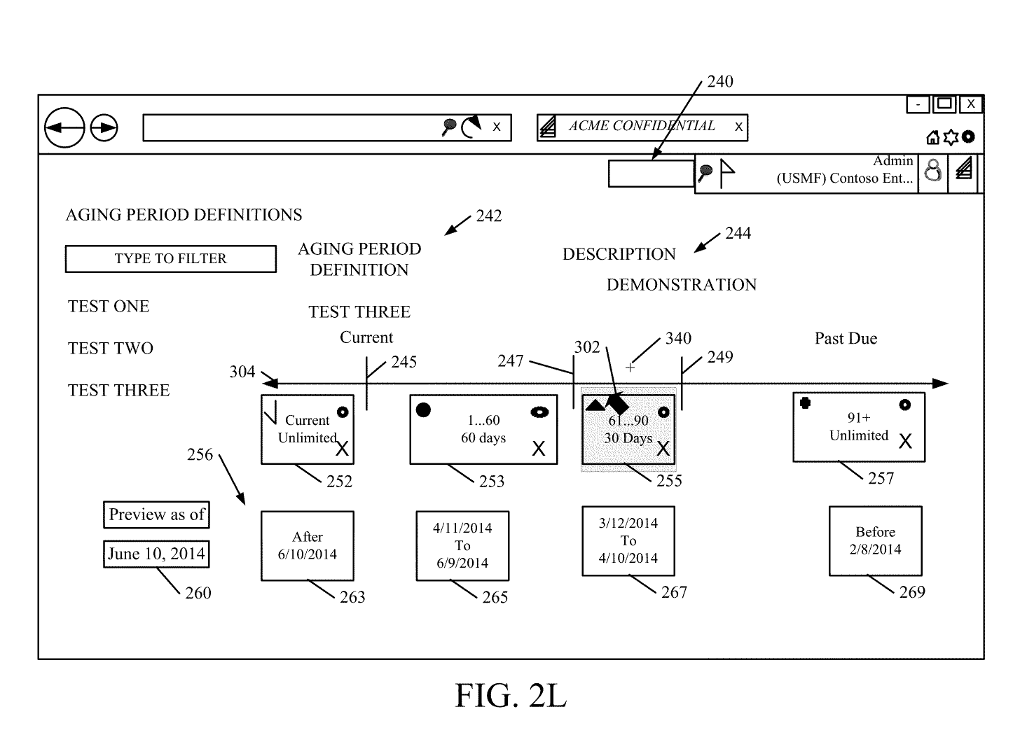

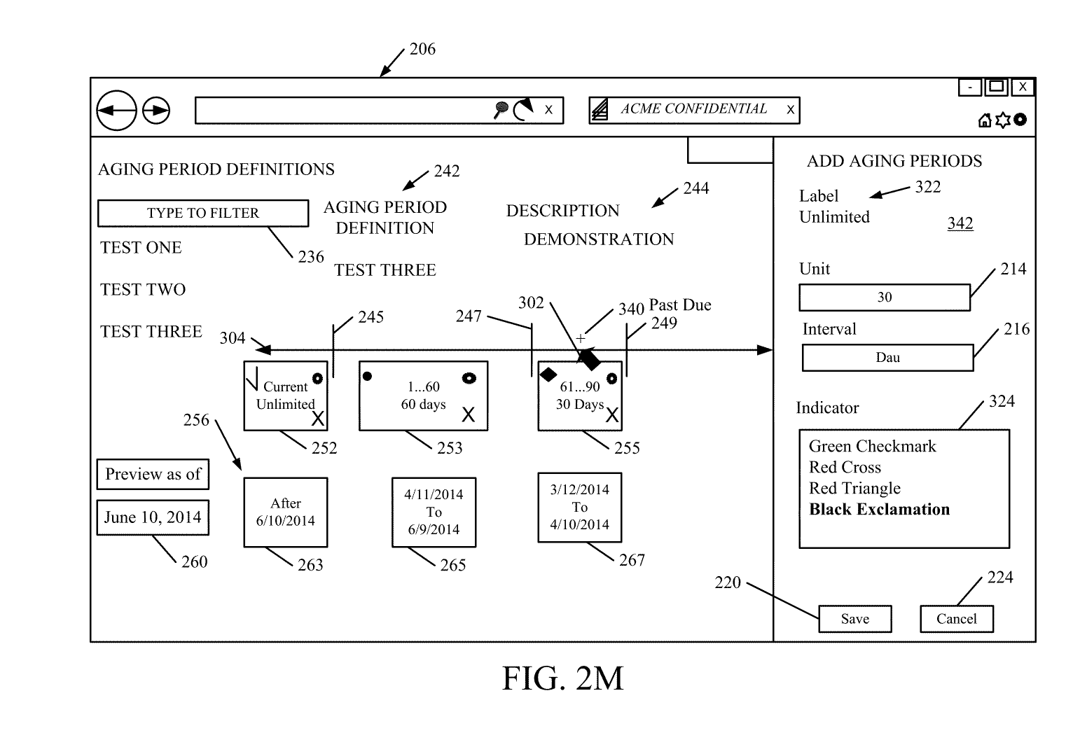

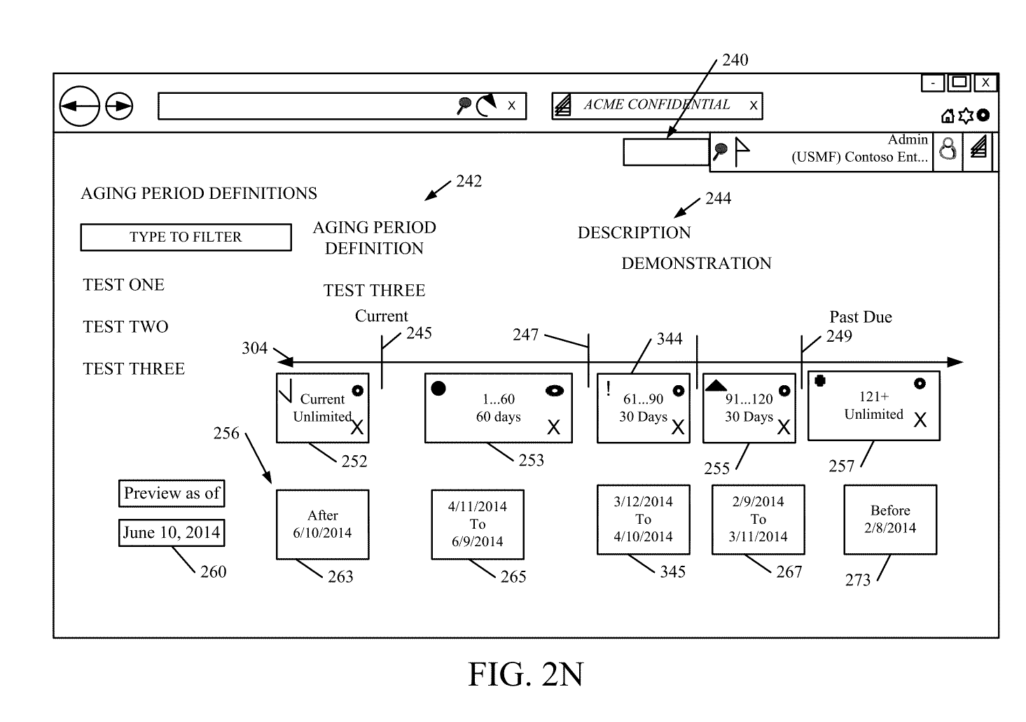

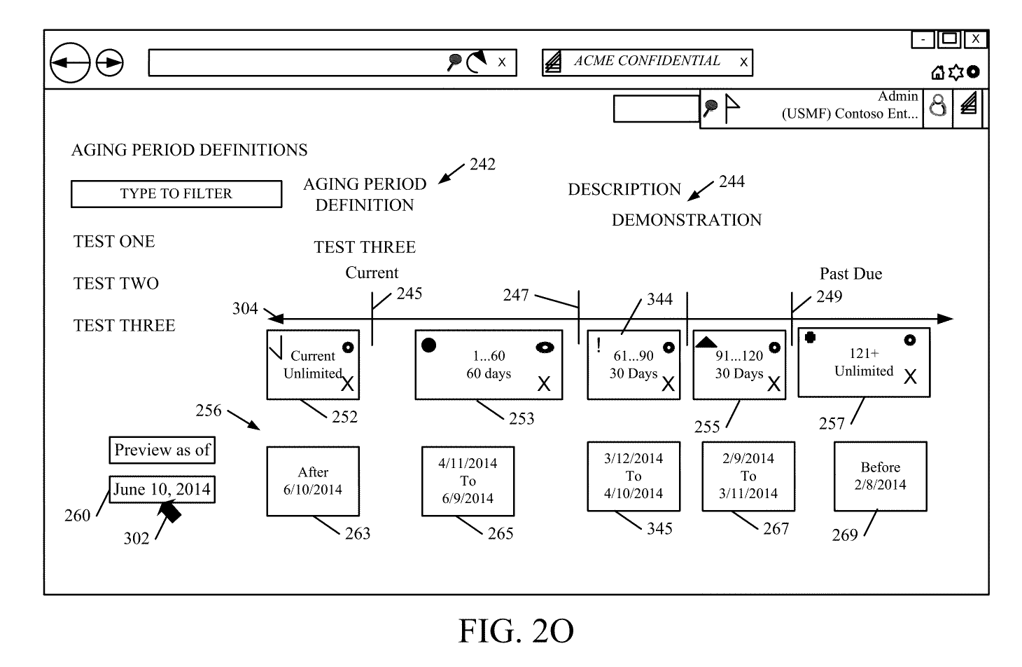

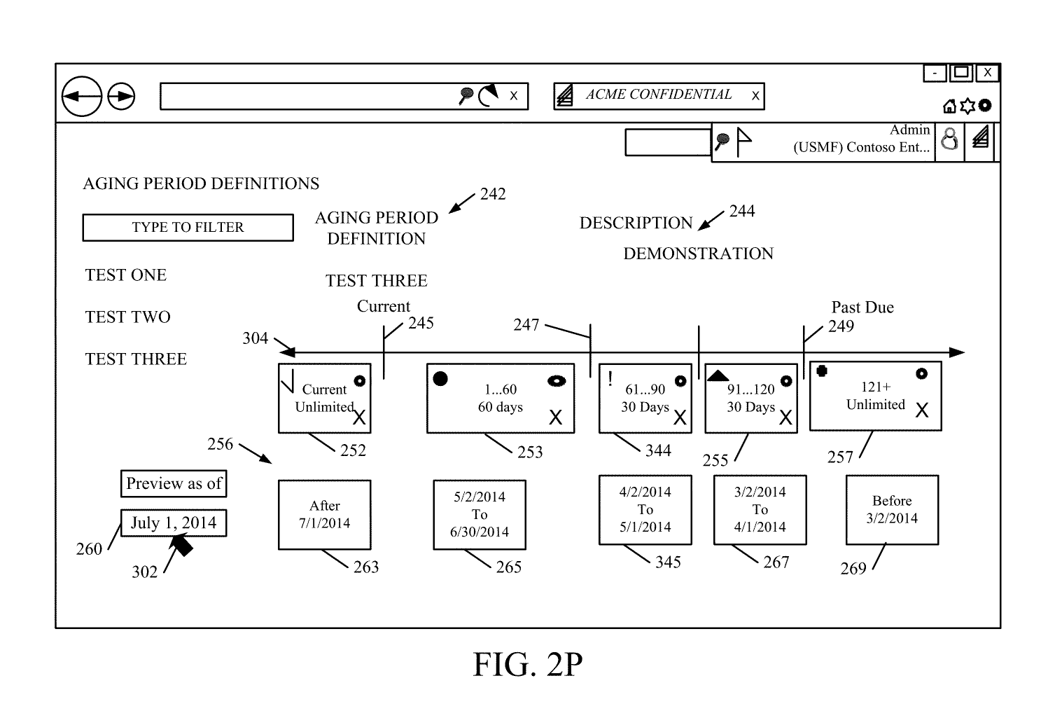

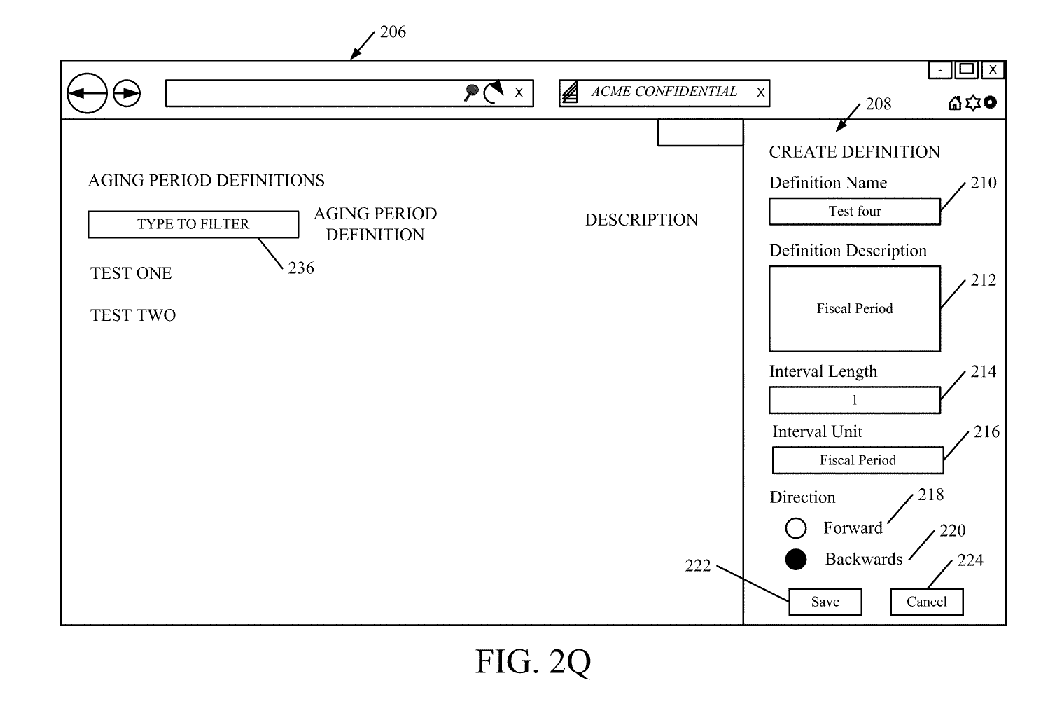

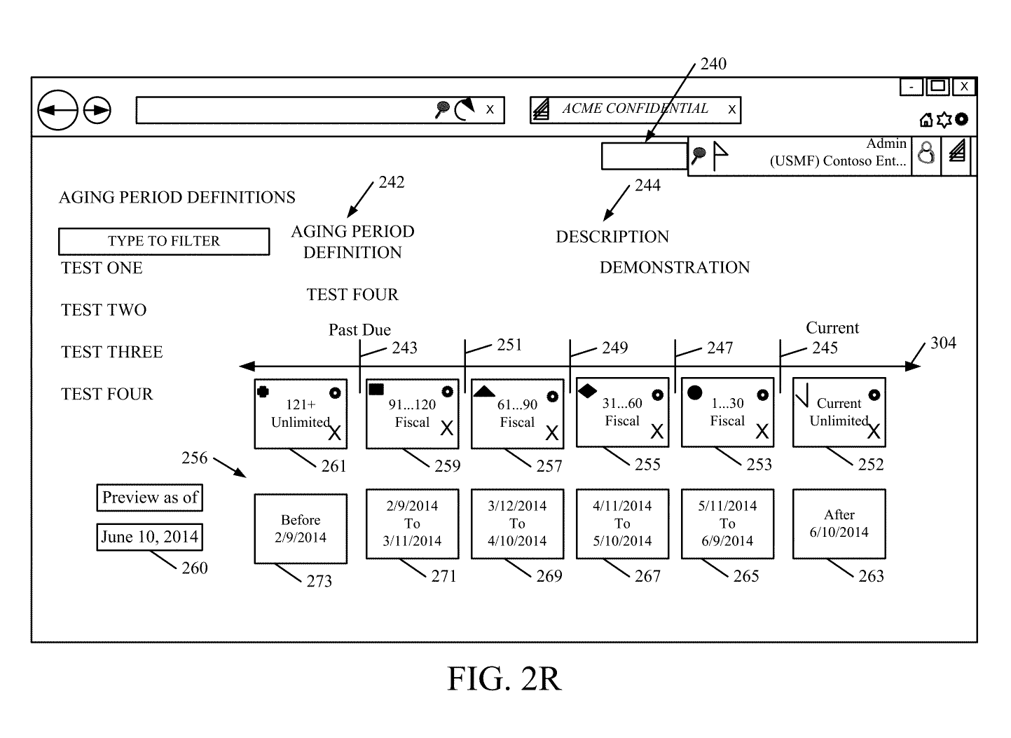

FIGS. 2-1 and 2-2 (collectively referred to herein as FIG. 2) show a flow diagram illustrating one example of the operation of aging period configuration engine 122. It will be described in terms of user 108 providing user inputs through corresponding user input mechanisms 106, in order to generate an aging period definition 128, so that aging display mechanism generator 155 can generate the aging display mechanism which can be rendered for interaction by user 108 or systems 110.

Computing system 102 first receives a user input accessing the computing system. This is indicated by block 180 in FIG. 2. For instance, user 108 can provide an authentication input 182, or other information 184. Aging period configuration engine 122 then receives a user input indicating that the user wishes to access the aging period configuration engine 122 in order to create an aging period definition. This is indicated by block 186. As briefly discussed above, the aging period definition can be used for substantially any transactions, and corresponding data, that are to be sorted based upon date, and arranged in series. This is indicated by block 188. Where the computing system 102 is a business system, for instance, the aging period definition can be applied to aged data 129 which is in the form of accounts receivable 190. It can be applied to accounts payable 192, or substantially any other aged data 194.

In response, aging period configuration engine 122, either by itself or using user interface component 116, illustratively generates an interface with input mechanisms that can be actuated to generate an aging period definition. For example, it can display an aging period creation pane with creation user input mechanisms. This is indicated by block 196. The user input mechanisms can include one or more definition identifier user input mechanisms 198, one or more interval user input mechanisms 200, one or more orientation user input mechanisms 202, or a variety of other input mechanisms 204.

FIG. 2A shows one example of a user interface display 206 that illustrates this. It can be seen that user interface display 206 illustratively includes an aging period creation display pane 208. Pane 208 includes a definition name user input mechanism 210, a definition description user input mechanism 212, an interval length user input mechanism 214, an interval unit user input mechanism 216, and a set of orientation user input mechanisms 218 and 220. In addition, pane 208 illustratively includes a save user input mechanism 222 and a cancel user input mechanism 224. User input mechanism 210 can take a wide variety of different forms that can be actuated by the user in order to identify a name for the aging period definition that is being created. In the example shown in FIG. 2A, user input mechanism 210 is a text box. It can be seen that user 108 has entered “Test 3” as the name for the aging period definition that is being created.

User input mechanism 212 can also take a wide variety of different forms, and can illustratively be actuated to provide a description of the aging period definition that is being created. In the example shown in FIG. 2A, input mechanism 212 is a text box, where user 108 has entered the description “Demonstration”.

User input mechanism 214 is illustratively actuated by user 108 to identify an interval length for the various intervals that are to be used in the aging period definition. In the example shown in FIG. 2A, mechanism 214 is a text box. The user has entered the interval length with a value of “30”.

User input mechanism 216 can be actuated by the user to identify the units that are used in the intervals. In the example shown in FIG. 2A, mechanism 216 is a menu (which can slide in, drop down, etc.) that can be actuated to select from among a plurality of different units. It can be seen in FIG. 2A that the user has actuated mechanism 216 to identify the units of the intervals to be measured in days.

User input mechanisms 218 and 220 can take a wide variety of different forms that allow the user to specify a particular orientation for the configuration of the aged data, when it is surfaced by system 102. In the example shown, mechanisms 218 and 220 are selectable radio buttons that allow the user to create the aging period definition to display the aged data in a forward direction (user input mechanism 218) or in a reverse or backwards direction (user input mechanism 220).

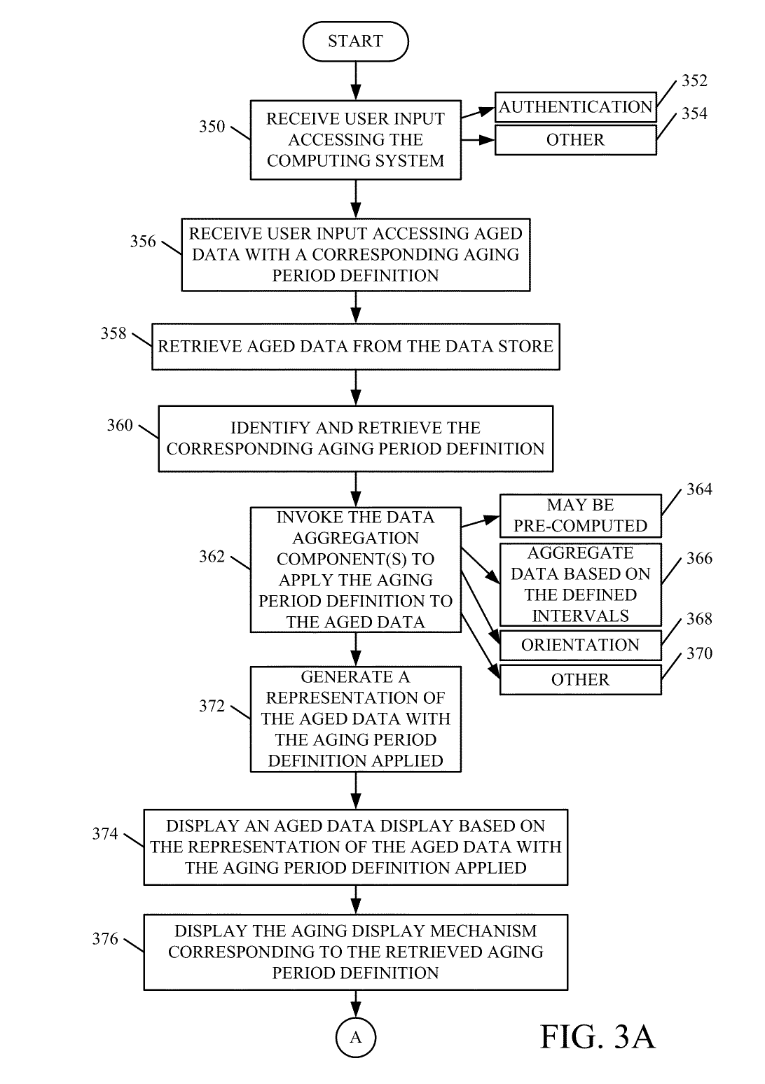

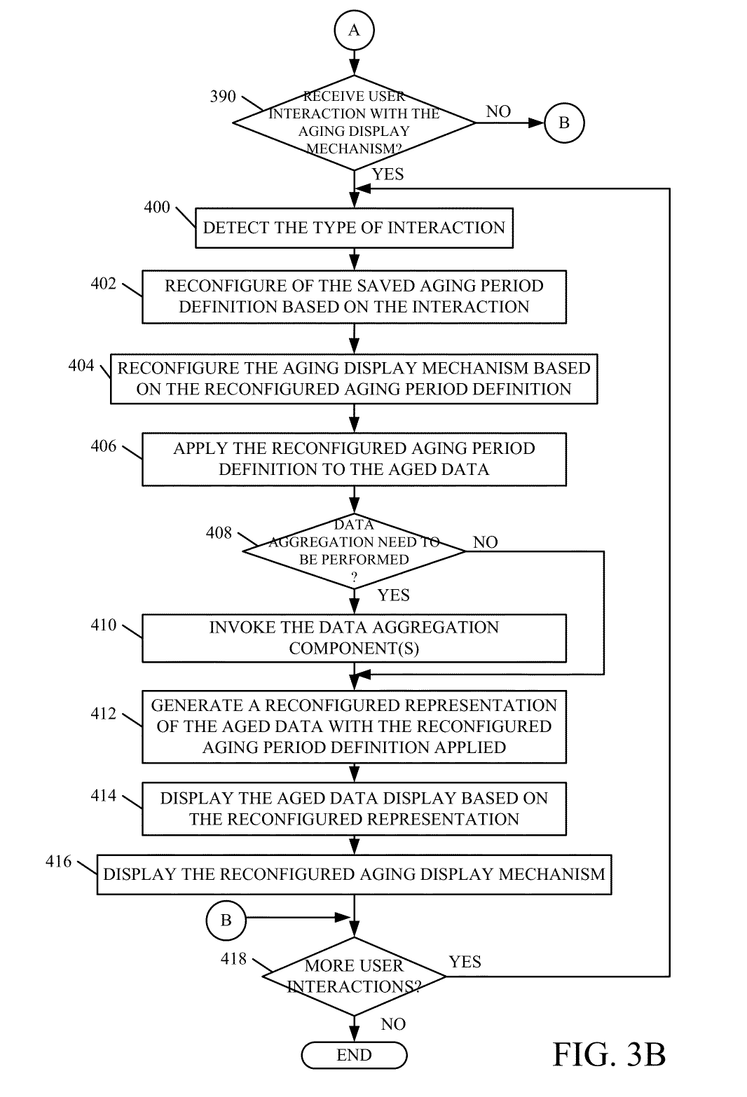

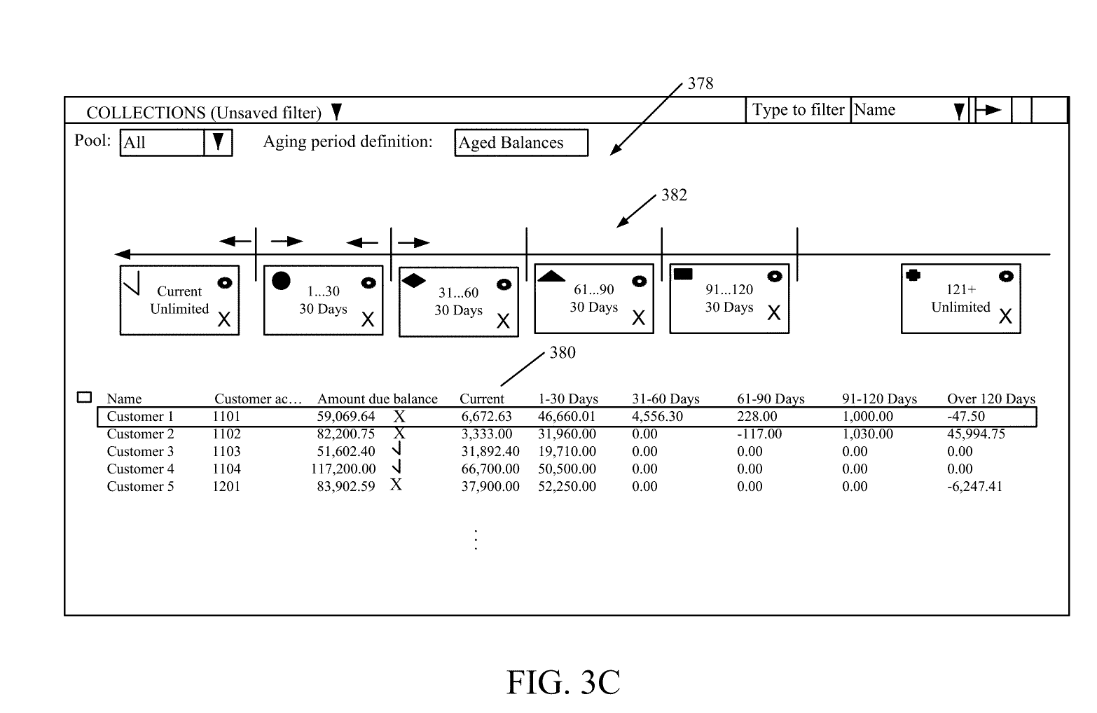

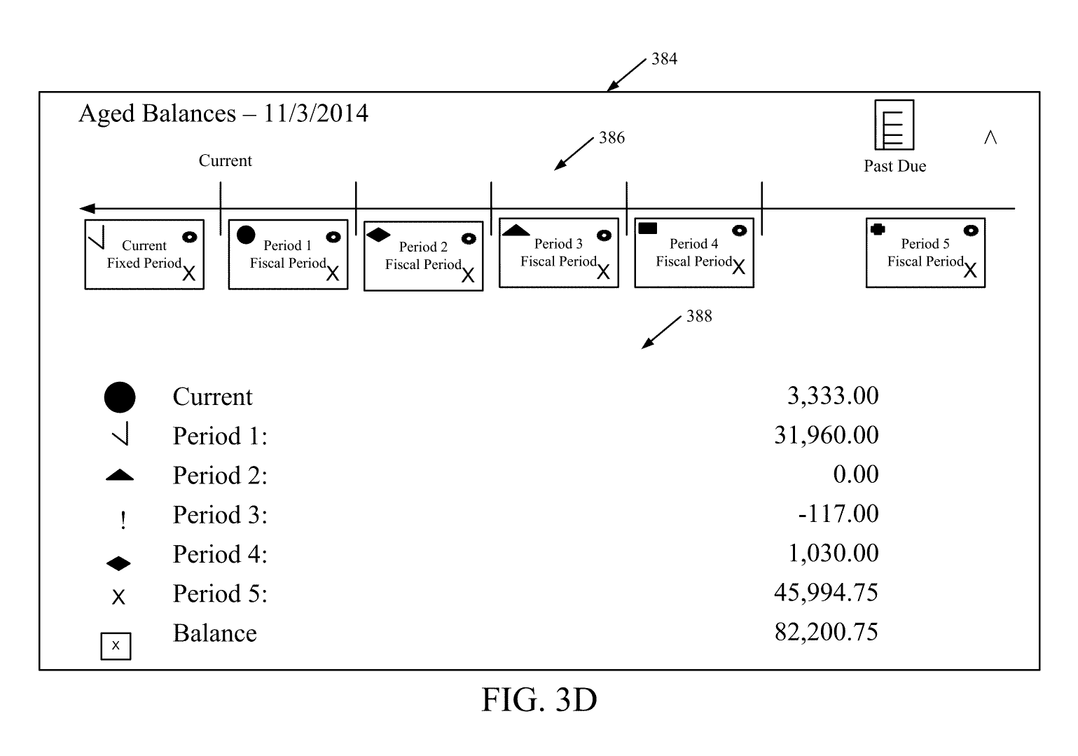

When the user actuates user input mechanism 222, the system illustratively saves the aging period definition to memory, so that it can be applied to aged data 129 during runtime. This is described in greater detail below with respect to FIG. 3.

Once the aging period creation pane 208 (and the user input mechanism) is displayed, aging period configuration engine 122 receives user inputs creating and configuring an aging period definition. This is indicated by block 226. Aging period definition component 144 detects that the user has actuated one or both of user input mechanisms 210 and 212, and uses this information to define (e.g., to name and to describe) the aging period definition that is being created. This is indicated by block 228.

Interval configuration component 146 illustratively detects that the user has actuated one or more of user input mechanisms 214 and 216. It uses the entered values or information in order configure the aging period definition being created to have the designated interval. This is indicated by block 230.

Orientation configuration component 152 detects that the user has actuated an orientation user input mechanism 218 or 220. It uses this information to configure the aging period definition being created to aggregate data so that it can be displayed in a forward or reverse orientation. This is indicated by block 232. It will be noted that aging period configuration engine 122 can receive other inputs as well, and this is indicated by block 232.

Once the user has finished creating the aging period definition, and the user actuates save user input mechanism 222, for instance, aging display mechanism generator 155 generates an aging display mechanism corresponding to the aging period definition that was just created. The aging display mechanism can be saved and later accessed and displayed to visually represent the aging period definition that was just created. Engine 122 then illustratively receives a user input to display the aging display mechanism for the created aging period definition. This is indicated by block 234. By way of example, the user may actuate the save user input mechanism 222 and then enter the name of the newly created aging period definition into a search box 236. In response, aging display mechanism generator 155 illustratively accesses the saved aging period definition and corresponding display mechanism and surfaces it so that user interface component 116 can display it for user 108. Displaying the aging display mechanism is indicated by block 238 in FIG. 2.

FIG. 2B shows one example of a user interface display 240 that indicates this. Display 240 illustratively includes an aging period definition display portion 242, a description display portion 244 and a display portion 246 that displays the aging display mechanism 248. In the example shown, display mechanism 248 illustratively includes a timeline 250, a set of aggregation display elements 252, 253, 255, 257, 259 and 261 a set of sliders 243, 245, 247, 249 and 251, a preview display section 256, and it can include other items 258. Preview display section 256 illustratively includes a beginning date display portion 260 and a set of offset portions 263, 265, 267, 269, 271, and 273. When the user enters a starting date in user input mechanism 260, each of the offset portions 263-273 display a date range that is defined in the aging period definition.

The aggregation display elements 252-261 can have various portions. Taking aggregation display element 259 as an example, each display element can have an interval span indicator 281 that identifies a number of days (or other units, e.g., months, weeks, etc.) that are represented by the interval. It also illustratively includes an offset display portion 283 that identifies a number of days offset from a date identified as a current date. For instance, it may be the number of days offset from the date entered in user input mechanism 260. Each aggregation display element can also include a corresponding graphical indicator 285 that can be mapped to a legend or other visual display element. Similarly, each display element can include a delete user input mechanism 287, and a settings user input mechanism 289. When the user actuates the delete user input mechanism 287, the interval represented by the corresponding display element will be deleted from the aging display mechanism 248, and it will also be deleted from the underlying aging period definition. For instance, edit processing system 162 not only deletes the interval from being visually represented by the aging display mechanism 248, but it deletes it from the underlying aging period definition 128 stored in data store 118. When the user actuates settings mechanism 289, the user can be navigated through a settings experience where settings can be changed.

It can be seen in FIG. 2B that timeline 150 is oriented in the forward direction, with the most current data listed on the left-hand side of timeline 250, and the oldest data listed on the right-hand side. It can also be seen that each of the aggregation display elements 252-259 correspond to a 30-day interval, and element 261 corresponds to an aggregation of everything over 121 days, because that is what was defined in the aging display definition created as described above with respect to FIG. 2A. Each of the display elements 252-261 can be selected and modified, as is described in greater detail below. Also, each of the sliders 243-251 are user input mechanisms that can be moved along timeline 250, in order to automatically adjust the aging display definition. This is also described in greater detail below. Preview display section 256 illustratively reacts to any changes to the display mechanism 246 and modifies the previewed information, accordingly.

It will be noted that the start date entered in user input mechanism 260 can initially be entered as a default date, such as the current date, or it can be selected by the user, or both. In any case, preview display section 256 adjusts itself to display the aged data based upon the date entered in user input mechanism 260 of the preview display section 256.

Once mechanism 248 is displayed, at some point, the user may wish to interact with mechanism 248 in order to have system 122 surface a different set of aged data 129, or in order to have the data aggregated differently or provided in a different configuration or format. In that case, interaction detector 158 in aging mechanism interaction system 154 detects the user interaction with the aging display mechanism 248. This is indicated by block 270 in FIG. 2. For instance, user 108 may enter a different preview date in user input mechanism 260. This is indicated by block 272. The user may select and move one of the sliders 243-251. This is indicated by block 274. The user may add or delete an aggregation display element 252-261. This is indicated by block 276. The user may invoke an edit panel that allows the user to edit mechanism 248 in a variety of different ways. This is indicated by block 278. The user may modify the orientation of mechanism 248. This is indicated by block 280. The user may change the labels on the various display elements on mechanism 248. This is indicated by block 282. The interaction detector 158 can detect that the user has interacted with mechanism 248 in other ways as well, and this is indicated by block 284.

In response to receiving user interaction, aging mechanism interaction system 154 illustratively revises the aging period definition 128 based upon the user inputs. This is indicated by block 286 in FIG. 2.

Aging display mechanism generator 155 then performs a reconfiguration of the aging display mechanism corresponding to the aging period definition 128 based on the revised aging period definition 128. This is indicated by block 288. For instance, where the user sets a preview date using user input mechanism 260, preview interaction processing system 164 illustratively revises the information in the preview display elements 256 to reflect that information. By way of example, as can be seen in FIG. 2B, the date in mechanism 260 is Jun. 10, 2014. Since the intervals are defined in terms of virtual offsets from the date entered in mechanism 260, the dates displayed in each of the display elements 263-273 in preview display portion 256 are calculated and displayed based on the date entered in mechanism 260. For instance, because the intervals are set at 30 days in length, the display element 252 corresponding to current aged data will have a preview date in the corresponding preview display element 263 of Jun. 10, 2014. The preview display element 265 for the next interval (1-30 days) will have the offset calculated by preview interaction processing system 164 to indicate that it spans the date range of 5-11-14 to 6-9-14. Preview interaction processing system 164 then calculates the offset interval for the next display element 267 and displays the dates 4-11-14 to 5-10-14, and so forth. Setting the preview dates and calculating the virtual offsets are indicated by block 290 in FIG. 2.

When the user moves one of sliders 243-251 along timeline 250, slider interaction processing system 160 automatically adjusts the remaining display elements 252-261 on the timeline to indicate that. In addition, the user can add or delete additional intervals. In that case, period addition/deletion component 170 automatically adds or deletes display elements to the display mechanism 248. In either case (where the user moves one of the sliders 243-251 or adds or deletes an interval display element 252-261, adjacent period auto-adjust component 172 calculates new interval boundaries and automatically adjusts the display mechanism 248 to accommodate for the changes input by the user. Automatically adjusting the periods is indicated by block 292 in FIG. 2. The user can perform other edits to the mechanism 248. This is indicated by block 294. Further, reconfiguring the aging display mechanism 248 in other ways is indicated by block 296. Some of these are described in greater detail below with respect to FIGS. 2D-2S.

At some point, the user will provide a user input indicating that the user wishes to save the aging period definition and the corresponding aging display mechanism 248. This is indicated by block 298. In one example, for instance, the user will provide an input indicating which particular application that the aging period definition is to be used in. This can be done by opening the aging period creation process within a given application 126 and saving the created aging period definition in that application as well. In another example, the aging period definition can be created, along with the aging display mechanism, and they can be saved separately in data store 118, separate from any of the applications. They can then be imported into the applications or otherwise used by the applications. All of these and other examples are contemplated herein.

In any case, aging period configuration engine 122 saves the aging period definition and a representation of the aging display mechanism 248 (which can be used to render a display of that mechanism) for use by the computing system 102, for use by one or more various applications in computing system 102, or otherwise. This is indicated by block 300 in FIG. 2.

A number of user interface displays will now be described in conjunction with FIG. 1, to illustrate some examples of how an aging period definition can be changed using a corresponding aging display mechanism 248. FIG. 2C shows another example of a user interface display. Some of the items in FIG. 2C are similar to those shown in FIG. 2B, and they are similarly numbered. FIG. 2C shows that the most current aged data display element 252 has been selected by a user. In the example shown in FIG. 2C, the user has placed a cursor 302 over that display element 252 and actuated it (such as by clicking on it, etc.). In another example, however, where the user interface display is a touch enabled display, the user can simply tap display element 252 to select it.

In any case, once the user has selected the first display element 252, the leading arrowhead 304 and the corresponding slider 245 become user actuatable input mechanisms. By dragging arrow 304 forward or backward, this changes the amount of data included in the first interval represented by the current aged data display element 252. The leading arrowhead 304 can be moved in either direction as indicated by the arrows 306.

Similarly, the slider 245 between the current aged data display element 252 and the display element 253 corresponding to the interval of days 1-30 can also be moved in the direction indicated by arrows 308. When it is moved forward, toward arrow 306, this will increase the amount of time in the next adjacent interval to the right. Thus, beginning date entered in user input mechanism 260 will change based upon movement of slider 245 either forward or backward in time along timeline 250. At the same time (or when slider 245 is released) then adjacent period auto-adjust component 172 (shown in FIG. 1) will then adjust all of the dates shown in display elements 263-273 in preview display section 256. Thus, for instance, if the user moves the first slider 245 forward (towards arrowhead 304) then the date in user input mechanism 260 will move forward in time (e.g., become more recent). If the user moves the slider rearward in time, then the date in user input mechanism will move to a time further in the past. All of the intervals represented by displays 253-261 will then be adjusted to count 30 days backward from the new preview date. Similarly, all of the display elements 263-273 will have dates adjusted in a corresponding fashion.

FIG. 2D shows another example of user interface display 240. Again, the user interface display 240 shown in FIG. 2D is similar to that shown in FIG. 2C, except that the user has now selected aggregation display element 253 instead of aggregation display element 252. In that case, both of the sliders 245 and 247 on either side of display element 253, on timeline 250, become active and can be moved by the user. FIG. 2D shows that the user is selecting the slider 247 on the trailing edge of aggregation display element 253.

FIG. 2E shows that the user has moved slider 247 to the rear along timeline 250. This is detected by interaction detector 158. Slider interaction processing system 160 then automatically adjusts aggregation display element 253 to indicate that the interval that it represents is now 60 days, instead of 30 days. Adjacent period auto-adjust component 172 also shifts all of the other aggregation display elements 255, 257, 259 and 261 to the right along timeline 250. It also adjusts the virtual offset identified in each of those display elements. For instance, now instead of display element 255 representing a 30 day offset from the previous time period, to cover days 31-60, it represents a 30 day offset from the previous time interval, but it covers days 61-90. This is because slider interaction processing system 160 has reconfigured display element 253 to correspond to a 60 day interval instead of a 30 day interval. Component 172 thus adjusts all of the display elements to the right of element 253 to accommodate for this. Thus, display element 257 now corresponds to a virtual offset of days 91-120, display element 259 corresponds to a virtual offset that covers days 121-150, and display element 261 corresponds to a virtual offset that corresponds to days 151 and beyond.

It can also be seen in FIG. 2E that preview interaction processing system 164 has reconfigured the preview display portion 256. For instance, it has revised the dates in preview display elements 265-273 to accommodate for the fact that the interval corresponding to aggregation display element 253 has been redefined to be a 60 day interval, instead of a 30 day interval.

FIG. 2F shows one example of a user interface illustrating yet another user interaction. FIG. 2F shows that the user is now actuating the delete user input mechanism 287 corresponding to aging display element 259. In that case, period addition/deletion component 170 deletes aggregation display element 259 from mechanism 248. It also illustratively deletes that interval from the corresponding aging period definition 128 stored in data store 118. Further, adjacent period auto-adjust component 172 adjusts all of the intervals to the right of that period, both in the aging period definition 128 and the aging display mechanism 148. FIG. 2G, for instance, now shows that display element 259 has been deleted and display element 261 has been updated. Display element 261 now corresponds to all of the data that is 121+ days offset from the current date.

In addition, preview interaction processing system 164 reconfigures any affected dates that are displayed in the preview display elements 263-273. For instance, it can be seen that it has now deleted display element 271 and has updated display element 273 so that its date corresponds to that represented by aggregation display element 261.

FIG. 2H shows yet another example of a user interaction. It can be seen in FIG. 2H that the user is now actuating the settings user input mechanism 289 on aggregation display element 257. Interaction detector 158 detects this, and edit processing system 162 then displays an edit user input mechanism, such as edit pane 320 shown in FIG. 2I. Pane 320 illustratively includes a set of user input mechanisms that are used to actuate the components in engine 122. The actuation can be used to reconfigure the aging period definition and its corresponding aging display mechanism.

In the example shown in FIG. 2I, some of the items are similar to those shown in the aging period creation pane illustrated in FIG. 2A, and they are similarly, numbered. However, FIG. 2I shows that edit pane 320 also includes a label editor user input mechanism 322 and an indicator user input mechanism 324. Mechanism 322 can be actuated to change the label of a corresponding aggregation display element from which the settings user input mechanism 289 was actuated. In the example shown in FIG. 2I, it can be seen that the user actuated the settings user input mechanism 289 on aggregation display element 257. Therefore, any modifications made using the user input mechanisms on pane 320 are illustratively applied, using edit processing system 162, to aggregation display element 257.

FIG. 2J is similar to FIG. 2I, except that it shows that the user has now selected a different indicator. The previous indicator was a “black triangle” indicator, and the newly selected indicator is a “red cross” indicator. In addition, the user has changed the label from “91 . . . 120” to “91+”.

FIG. 2K shows that the user has now actuated the save mechanism 220 (shown in FIG. 2J). In response, edit processing system 162 has now implemented the changes to aggregation display element 257. For instance, it has replaced the black triangle indicator 285 with a red cross indicator 285. It has also changed the label from “91 . . . 120” to “91+”. Therefore, adjacent period auto-adjust component 172 has now deleted aggregation display elements 259 and 261, because they are now both included in the interval represented by display element 257. Similarly, preview interaction processing system 164 has now modified the display in preview display element 269 to show the relevant date range. It has also deleted the preview display elements corresponding to the deleted time intervals.

FIG. 2L shows that, in one example, another user input mechanism can also be used to make changes to the timeline 250 and the corresponding display elements related to the timeline 250. As an example, it can be seen that the user in FIG. 2L is now hovering the cursor 302 over the aggregation display element 255. This causes edit processing system 162 to display an add user input mechanism 340. Mechanism 340, when actuated by the user, illustratively displays an add pane 342, as illustrated in FIG. 2M. Add pane 342 includes user input mechanisms that can be actuated by the user in order to have system 154 add intervals to the aging display mechanism 248. The user input mechanisms are similar to those shown in FIG. 2I, and they are similarly numbered. However, when the user enters information using those input mechanisms on pane 342, period addition/deletion component 170 then adds a period to the aging period definition corresponding to those user inputs. In addition, aging display mechanism generator 155 adds the period to the aging display mechanism as well. Similarly, adjacent period auto-adjust component 172 adjusts all of the periods to the right of the added period accordingly. Preview interaction processing system 164 adjusts the information displayed in preview display portion 256 as well.

FIG. 2N shows one example in which the user has added a 30 day interval before the interval represented by display element 255. Therefore, aggregation display element 344 is added along timeline 250. In addition, display elements 255 and 257 are adjusted, as are the corresponding preview displays in preview display portion 256.

FIGS. 2O and 2P illustrate a user interaction where the user is changing the current date in user input mechanism 260. It can be seen in FIG. 2O that the user can select user input mechanism 260 using cursor 302 (or using a touch gesture or otherwise). The user can then enter a new date. For instance, FIG. 2P shows that the user has changed the date from Jun. 10, 2014 to Jul. 1, 2014. Preview interaction processing system 164 then adjusts all of the dates in the preview display elements to reflect that change. Similarly, because all of the periods are virtual offsets from the current date that was just changed in user input mechanism 260, all of the dates in the preview display elements will be changed to reflect that.

FIGS. 2Q and 2R are similar to FIGS. 2A and 2B. However, in FIG. 2Q, it can be seen that the user has selected the interval unit to be a fiscal period. This is done using user input mechanism 216. Also, the user has actuated the backwards orientation user input mechanism 220, instead of the forward orientation user input mechanism 218. FIG. 2R thus shows that timeline 250 is now oriented in the opposite direction of that shown in FIG. 2B, and the intervals corresponding to each aggregation display element are fiscal intervals instead of intervals measured in days. As one example, a fiscal period may be a month instead of a certain number of days. Thus, the number of days will change with the month.

It should also be noted that, in one example, the various intervals can be configured using different units. For instance, a first set of intervals on a timeline 250 may be a specific number of days, while the remaining intervals are fiscal intervals. This may be helpful, for instance, where a user or other processing system wishes to obtain information that indicates what amount of aged data lies in the first 10 days, the first 15 days, and thereafter in fiscal intervals. Of course, this is only one example.

It can thus be seen that engine 122 can be used to very quickly allow a user or another processing system to configure an aging period definition and also the corresponding aging display mechanism. The aging display mechanism, itself, illustratively has user input mechanisms that can be actuated to control the underlying logic and circuitry in order to modify the aging period definition and to modify the aging display mechanism. This can be done quickly using touch gestures or otherwise. This eliminates errors in configuring aging period definitions and it also allows the user to quickly surface relevant information without needing to resort to a cumbersome, error-prone process by which the user engages a grid-based user input mechanism. This also greatly enhances the use of the configuration user input mechanism on relatively small screen devices. Because the aging period definition can be configured using a timeline with sliders and previews, the definition can be easily changed without incurring errors that often result from attempting to modify such a definition on a grid-based display user input mechanism.

FIGS. 3A-3B (collectively referred to as FIG. 3) illustrate one example of the operation of engine 122, runtime interaction engine 166, data aggregation component 120, and other items in computing system 102, during runtime. Computing system 102 first receives a user input indicating that the user wishes to access the computing system. This is indicated by block 350 in FIG. 3. For instance, the user can provide authentication information 352, or other information 354. Computing system 102 then receives a user input indicating that the user wishes to access aged data with a corresponding aging period definition. This is indicated by block 356.

By way of example, it may be that a user is in an application 126 that accesses aged data. A corresponding aging period definition 128 may have already been configured for that application and it will thus have a corresponding aging display mechanism associated with it. In that case, data aggregation component 120 retrieves the aged data 129 from data store 118. This is indicated by block 358. For instance, it may be that the application is accessing aged accounts receivable data, accounts payable data, etc. Data aggregation component 120 accesses that data. Data aggregation component 120 also accesses the aging period definition 128 corresponding to the application or aged data being accessed. The definition 128 may be associated with the data or the application or both, in memory. Thus, component 120 accesses the relevant aging period definition 128. This is indicated by block 360.

Data aggregation component 120 then applies the aging period definition 128 to the aged data 129 that was retrieved. This is indicated by block 362. It should be noted that application of the aging period definition 128 to the aged data 129 can be pre-computed, and intermittently updated. This is indicated by block 364. It can also be performed during runtime.

In applying the aging period definition, data aggregation component 120 illustratively aggregates the aged data into collections or groups based on the defined intervals in the aging period definition 128. This is indicated by block 366. It also illustratively generates a representation of that grouped, aged data 129 according to an orientation that is identified by the aging period definition 128. This is indicated by block 368. It can apply other characteristics of the aging period definition 128 as well, and this is indicated by block 370. Data aggregation component 120 then generates a representation of the aged data 129 with the aging period definition 128 applied to it. This is indicated by block 372. It then displays an aged data display that is indicative of the representation of the aged data with the aging period definition 128 applied to it. This is indicated by block 374. In addition, in one example, it also displays the corresponding aging display mechanism that identifies the particular configuration of the aging period definition 128. This is indicated by block 376.

Before continuing with the description of the flow diagram in FIG. 3, a number of examples will first be discussed. FIG. 3C, for instance, shows one example of a user interface display 378. User interface display 378 includes an aged data display portion 380 that displays aged data for a plurality of different customers. For instance, the aged data is account balances broken down into 30 day periods and displayed in an orientation where the most current account balances are displayed on the left and the most aged account balances are displayed on the right. User interface display 378 also illustratively includes a display of the aging display mechanism 382 corresponding to the underlying aging period definition that was used to create the aged data display 380. It can be seen that it is the same as aging display mechanism 248 shown in FIG. 2B.

In the example shown in FIG. 3C, the same user input mechanisms that were actuatable and configurable in FIG. 2B (and the corresponding discussion) are also actuatable and configurable in FIG. 3C. Thus, the user can move the various sliders to accommodate a change in the aging period definition that is applied to the aged data shown at 380. The user can also delete intervals, change the interval units, change the size of the intervals, add intervals, and change other characteristics of the aged display mechanism 382, etc. In response, runtime interaction engine 166 invokes data aggregation component 120, and the various components in aging period configuration engine 122 to change the underlying aging period definition that was applied to the data, to change the aging display mechanism 382, and to invoke data aggregation component 120 to aggregate data into different groups, based upon the change to the underlying aging period definition.

FIG. 3D shows yet another example. FIG. 3D shows a user interface display 384 that includes an aging display mechanism 386 and a corresponding aged data display 388 that shows the aged data, after it has been aggregated by data aggregation component 120 and had the aging period definition 128 (represented by aging display mechanism 386) applied to it. In the example shown in FIG. 3D, the intervals are measured in fiscal units, instead of days. This is but one example. Again, as the user reconfigures aging display mechanism 386, runtime interaction engine 166 invokes the various components of engine 122 and data aggregation component 120 to change the underlying aging period definition 128, the corresponding aging display mechanism 386, and to re-aggregate the data into different aged groups based on those changes.

Now continuing on with the description of the flow diagram in FIG. 3, engine 122 can receive user interaction with the aging display mechanism (such as aging display mechanism 382 or 386 in FIGS. 3C and 3D). This is indicated by block 390. If the user does interact with the displayed mechanisms, interaction detector 158 detects the type of user interaction. This is indicated by block 400 in FIG. 3. Runtime interaction engine 166 then reconfigures the saved aging period definition 128 based on the user interaction. This is indicated by block 402. Aging display mechanism display generator 158 also reconfigures the aging display mechanism based on the reconfigured aging definition. This is indicated by block 404.

Runtime interaction engine 166 then applies the reconfigured aging period definition to the aged data. This is indicated by block 406. It may be that, based upon the user interaction, the data aggregation component 120 needs to re-aggregate the aged data 129, because, for instance, the intervals have changed. If that is the case, or if the aged data needs to be re-aggregated for any other reason, based upon the user interactions, then runtime interaction engine 166 invokes data aggregation component 120 to re-aggregate the aged data to reflect the user interactions. This is indicated by blocks 408 and 410. Engine 166 then generates a reconfigured representation of the aged data with the reconfigured aging period definition applied. This is indicated by block 412. It then displays the aged data display based on the reconfigured data representation. This is indicated by block 414. It also displays the reconfigured aging display mechanism, itself, as indicated by block 416. In this way, if the user again wishes to reconfigure the underlying aging period definition 128, the user can do so with the aging display mechanism that is displayed along with the aged data display.

If the user interacts anymore with the aged data display or the reconfigured aging display mechanism, processing reverts to block 400 where the interactions are implemented. This is indicated by block 418.

It can thus be seen that the present system provides a visual representation of the aging period definition as a timeline where aging periods are represented by blocks of time on the timeline. This provides a greatly enhanced user interface that enables touch gestures to be implemented much more easily. The user input mechanism can be actuated to add an aging period at any position on the existing aging period definition timeline by simply actuating or clicking on the timeline where one intends to add the period. The length of each period can easily be modified by simply grabbing a slider on the aging period timeline and moving it to the left or right. The adjacent time periods are automatically updated to reflect the movement of the slider. The aging periods can easily be deleted and all of the remaining aging periods, that are affected by the deletion, are adjusted to fill the gap in the timeline where the aging period was deleted. A preview is provided that indicates how an aging period definition would appear as of a certain date. Thus, the present system provides a significantly enhanced graphical user interface which greatly improves user efficiency and reading efficiency. It quickly communicates to the user how the underlying aging period is defined, and allows the user to easily modify that definition. It greatly enhances the likelihood that an aging period definition can be configured and revised without error.

The present discussion has mentioned processors and servers. In one embodiment, the processors and servers include computer processors with associated memory and timing circuitry, not separately shown. They are functional parts of the systems or devices to which they belong and are activated by, and facilitate the functionality of the other components or items in those systems.

Also, a number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

A number of data stores have also been discussed. It will be noted they can each be broken into multiple data stores. All can be local to the systems accessing them, all can be remote, or some can be local while others are remote. All of these configurations are contemplated herein.

Also, the figures show a number of blocks with functionality ascribed to each block. It will be noted that fewer blocks can be used so the functionality is performed by fewer components. Also, more blocks can be used with the functionality distributed among more components.

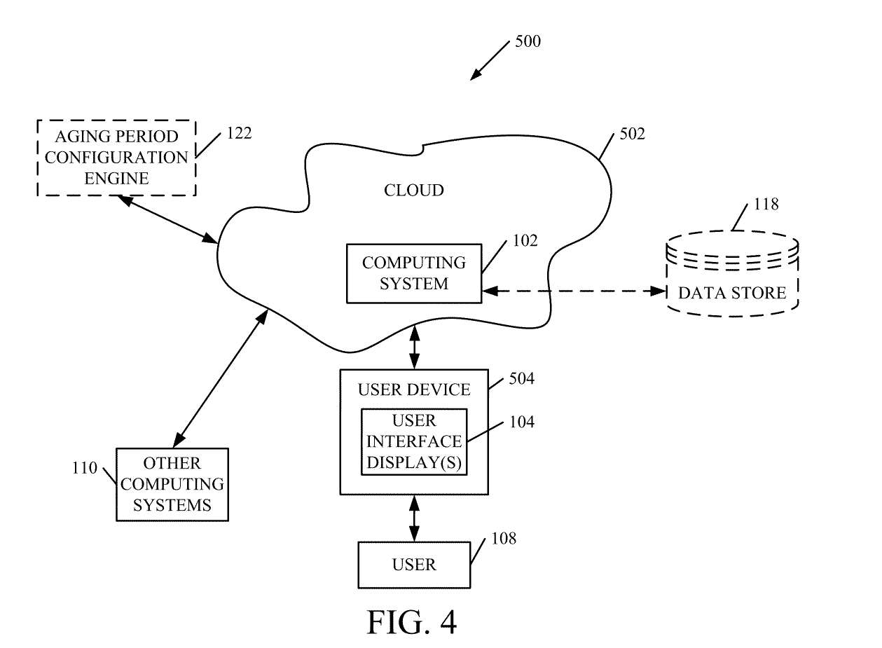

FIG. 4 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the example shown in FIG. 4, some items are similar to those shown in FIG. 1 and they are similarly numbered. FIG. 4 specifically shows that computing system 102 is located in cloud 502 (which can be public, private, or a combination where portions are public while others are private). Therefore, user 108 uses a user device 504 to access those systems through cloud 502.

FIG. 4 also depicts another example of a cloud architecture. FIG. 4 shows that it is also contemplated that some elements of computing system 102 can be disposed in cloud 502 while others are not. By way of example, data store 118 can be disposed outside of cloud 502, and accessed through cloud 502. In another example, aging period configuration engine 122 can also be outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

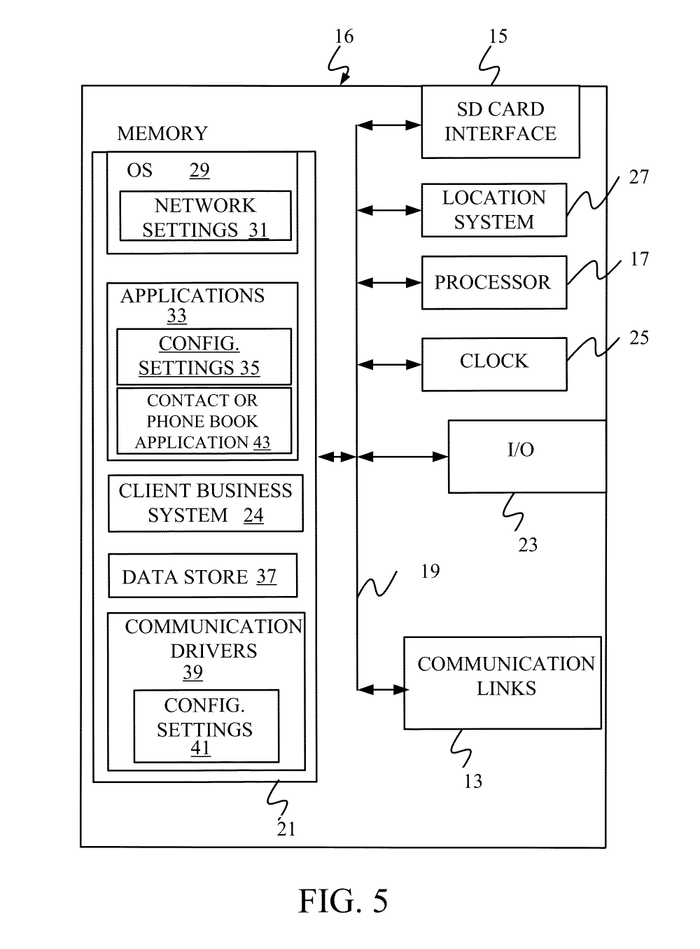

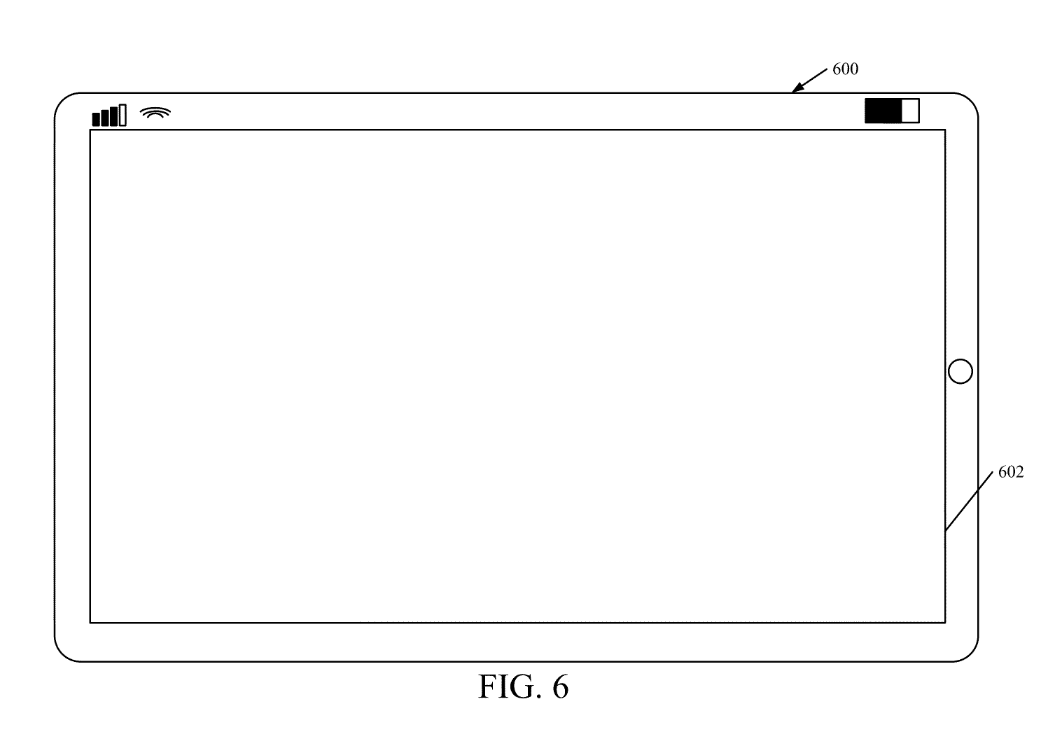

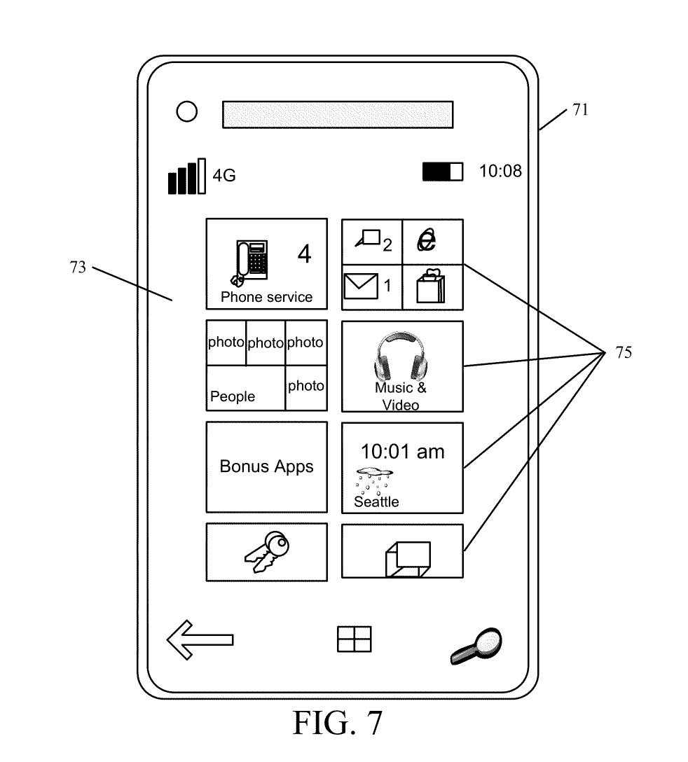

FIG. 5 is a simplified block diagram of one illustrative example of a handheld or mobile computing device that can be used as a user's or client's hand held device 16, in which the present system (or parts of it) can be deployed. FIGS. 6-7 are examples of handheld or mobile devices.

FIG. 5 provides a general block diagram of the components of a client device 16 that can run components of computing system 102 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as Wi-Fi protocols, and Bluetooth protocol, which provide local wireless connections to networks.

Under other examples, applications or systems are received on a removable Secure Digital (SD) card that is connected to a SD card interface 15. SD card interface 15 and communication links 13 communicate with a processor 17 (which can also embody processor 114 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 6 shows one example in which device 16 is a tablet computer 600. In FIG. 6, computer 600 is shown with user interface display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

Additional examples of devices 16 can be used. Device 16 can be a feature phone, smart phone or mobile phone. The phone can include a set of keypads for dialing phone numbers, a display capable of displaying images including application images, icons, web pages, photographs, and video, and control buttons for selecting items shown on the display. The phone can include an antenna for receiving cellular phone signals such as General Packet Radio Service (GPRS) and 1Xrtt, and Short Message Service (SMS) signals. In some examples, the phone also includes a Secure Digital (SD) card slot that accepts a SD card.

The mobile device can also be a personal digital assistant (PDA) or a multimedia player or a tablet computing device, etc. (hereinafter referred to as a PDA). The PDA can include an inductive screen that senses the position of a stylus (or other pointers, such as a user's finger) when the stylus is positioned over the screen. This allows the user to select, highlight, and move items on the screen as well as draw and write. The PDA can also include a number of user input keys or buttons which allow the user to scroll through menu options or other display options which are displayed on the display, and allow the user to change applications or select user input functions, without contacting the display. Although not shown, the PDA can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections.

FIG. 7 shows that the phone can be a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

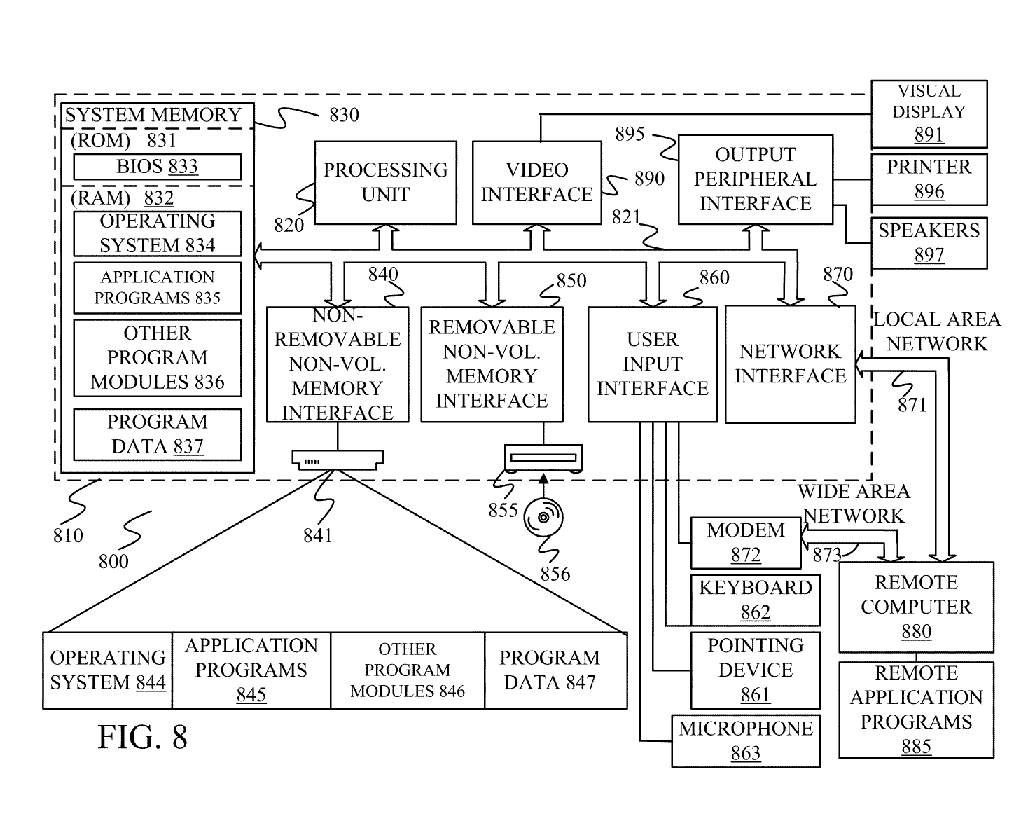

FIG. 8 is one example of a computing environment in which architecture 100, or parts of it, (for example) can be deployed. With reference to FIG. 8, an example system for implementing some embodiments includes a general-purpose computing device in the form of a computer 810. Components of computer 810 may include, but are not limited to, a processing unit 820 (which can comprise processor 114), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 8.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 8 illustrates operating system 834, application programs 835, other program modules 836, and program data 837.

The computer 810 may also include other removable/non-removable volatile/nonvolatile computer storage media. By way of example only, FIG. 8 illustrates a hard disk drive 841 that reads from or writes to non-removable, nonvolatile magnetic media, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and optical disk drive 855 is typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 8, provide storage of computer readable instructions, data structures, program modules and other data for the computer 810. In FIG. 8, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 8 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 8 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Example 1 is a computing system, comprising:

an aging period definition component that displays an aging period configuration user input mechanism configured to receive an interval configuration user input and configure an aging period definition with aging intervals, representing intervals of aged data, based on the interval configuration user input;

an aging display mechanism generator configured to generate an aging display mechanism based on the aging period definition, the aging display mechanism having a timeline and user actuatable interval slider mechanisms displayed at boundaries between the aging intervals on the timeline, the interval slider mechanisms being configured to be actuated to move along the timeline based on a slider user input; and

a slider interaction processing system configured to modify the aging intervals, in the aging period definition, on opposite sides of a given interval slider mechanism based on movement of the given interval slider mechanism along the timeline.

Example 2 is the computing system of any or all previous examples wherein the aging display mechanism generator is configured to generate an aggregation display element corresponding to each aging interval, displayed along the timeline generally between the interval slider mechanisms, each aggregation display element displaying an interval duration indicator indicative of an offset of the corresponding aging interval relative to a selected date.

Example 3 is the computing system of any or all previous examples and further comprising:

an edit processing system configured to modify the interval duration indicators in the aggregation display elements based on movement of the interval slider mechanisms.

Example 4 is the computing system of any or all previous examples and further comprising:

a preview configuration component configured to generate a preview display element corresponding to each aging interval, displayed proximate a corresponding aggregation display element, the preview display element displaying a date range indicator indicating a date range of the corresponding aging interval.

Example 5 is the computing system of any or all previous examples and further comprising:

a preview interaction processing system configured to modify the date range indicator based on changes to the corresponding aging interval from movement of one of the interval slider mechanisms.

Example 6 is the computing system of any or all previous examples wherein the preview configuration component is configured to generate a preview date user input mechanism that is actuated to identify the selected date.

Example 7 is the computing system of any or all previous examples wherein the preview interaction processing system is configured to modify the date range indicators in the preview display elements based on a change to the selected date by the preview date user input mechanism.

Example 8 is the computing system of any or all previous examples and further comprising:

an orientation configuration component configured to generate an orientation user input mechanism that is actuated to identify an orientation of the timeline, the aging display mechanism generator being configured to display the timeline based on the identified orientation.

Example 9 is the computing system of any or all previous examples and further comprising:

a data aggregation component configured to access the aged data and the aging period definition and aggregate the aged data based on the aging intervals in the aging period definition, and display the aged data aggregated in the aging intervals.

Example 10 is the computing system of any or all previous examples and further comprising:

a runtime interaction engine configured to display the aging display mechanism along with the aged data.

Example 11 is the computing system of any or all previous examples wherein the run time interaction engine is configured to modify the aging period definition, to obtain a modified aging period definition, using the aging period definition component based on runtime interaction with the aging display mechanism and to obtain from the aging display mechanism generator a modified aging display mechanism.

Example 12 is the computing system of any or all previous examples wherein the data aggregation component is configured to re-aggregate the aged data based on the modified aging period definition and display the re-aggregated data along with the modified aging display mechanism.

Example 13 is a computing system, comprising:

an aging display mechanism generator configured to generate an aging display mechanism based on an aging period definition, the aging display mechanism having a timeline and user actuatable interval slider mechanisms displayed at boundaries between aging intervals on the timeline, the aging intervals representing intervals of aged data, the interval slider mechanisms being configured to be actuated to move along the timeline based on a slider user input; and

a slider interaction processing system configured to modify the aging intervals, in the aging period definition, on opposite sides of a given interval slider mechanism based on movement of the given interval slider mechanism along the timeline.

Example 14 is the computing system of any or all previous examples and further comprising:

a data aggregation component configured to access the aged data and the aging period definition and aggregate the aged data based on the aging intervals in the aging period definition, and display the aged data aggregated in the aging intervals.

Example 15 is the computing system of any or all previous examples and further comprising:

a runtime interaction engine configured to display the aging display mechanism along with the aged data.

Example 16 is the computing system of any or all previous examples wherein the run time interaction engine is configured to modify the aging period definition, to obtain a modified aging period definition based on runtime interaction with the aging display mechanism and to obtain from the aging display mechanism generator a modified aging display mechanism.

Example 17 is the computing system of any or all previous examples wherein the data aggregation component is configured to re-aggregate the aged data based on the modified aging period definition and display the re-aggregated data along with the modified aging display mechanism.

Example 18 is the computing system of any or all previous examples and further comprising:

an aging period definition component that displays an aging period configuration user input mechanism configured to receive an interval configuration user input and configure the aging period definition with the aging intervals based on the interval configuration user input.

Example 19 is a computer readable storage medium storing computer readable instructions which, when executed by a computer, cause the computer to perform a method, comprising:

displaying an aging display mechanism based on an aging period definition, the aging display mechanism having a timeline and user actuatable interval slider mechanisms displayed at boundaries between aging intervals on the timeline, the aging intervals representing intervals of aged data;

aggregating the aged data based on the aging intervals in the aging period definition;

displaying the aged data aggregated in the aging intervals, along with the aging display mechanism;

receiving user actuation of a given interval slider mechanism;

visually moving the given interval slider mechanism along the timeline of the aging display mechanism based on the user actuation;

modifying the aging intervals, in the aging period definition, on opposite sides of the given interval slider mechanism based on the movement of the given interval slider mechanism along the timeline;

re-aggregating the aged data based on the modified aging intervals; and

displaying the re-aggregated aged data.

Example 20 is the computer readable storage medium of any or all previous examples and further comprising:

displaying an aging period configuration user input mechanism;

receiving an interval configuration user input; and

configuring the aging period definition with the aging intervals based on the interval configuration user input.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing system, comprising:
an aging period definition component that displays an aging period configuration user input mechanism configured to receive an interval configuration user input and configure an aging period definition with aging intervals, representing intervals of aged data, based on the interval configuration user input;
an aging display mechanism generator configured to generate an aging display mechanism based on the aging period definition, the aging display mechanism having a timeline and user actuatable interval slider mechanisms displayed at boundaries between the aging intervals on the timeline, the interval slider mechanisms being configured to be actuated to move along the timeline based on a slider user input; and
a slider interaction processing system configured to modify the aging intervals, in the aging period definition, on opposite sides of a given interval slider mechanism based on movement of the given interval slider mechanism along the timeline.

2. The computing system of claim 1 wherein the aging display mechanism generator is configured to generate an aggregation display element corresponding to each aging interval, displayed along the timeline generally between the interval slider mechanisms, each aggregation display element displaying an interval duration indicator indicative of an offset of the corresponding aging interval relative to a selected date.

3. The computing system of claim 2 and further comprising:
an edit processing system configured to modify the interval duration indicators in the aggregation display elements based on movement of the interval slider mechanisms.

4. The computing system of claim 2 and further comprising:
a preview configuration component configured to generate a preview display element corresponding to each aging interval, displayed proximate a corresponding aggregation display element, the preview display element displaying a date range indicator indicating a date range of the corresponding aging interval.

5. The computing system of claim 4 and further comprising:
a preview interaction processing system configured to modify the date range indicator based on changes to the corresponding aging interval from movement of one of the interval slider mechanisms.

6. The computing system of claim 4 wherein the preview configuration component is configured to generate a preview date user input mechanism that is actuated to identify the selected date.

7. The computing system of claim 5 wherein the preview interaction processing system is configured to modify the date range indicators in the preview display elements based on a change to the selected date by the preview date user input mechanism.

8. The computing system of claim 5 and further comprising:
an orientation configuration component configured to generate an orientation user input mechanism that is actuated to identify an orientation of the timeline, the aging display mechanism generator being configured to display the timeline based on the identified orientation.

9. The computing system of claim 8 and further comprising:
a data aggregation component configured to access the aged data and the aging period definition and aggregate the aged data based on the aging intervals in the aging period definition, and display the aged data aggregated in the aging intervals.

10. The computing system of claim 9 and further comprising:
a runtime interaction engine configured to display the aging display mechanism along with the aged data.

11. The computing system of claim 10 wherein the run time interaction engine is configured to modify the aging period definition, to obtain a modified aging period definition, using the aging period definition component based on runtime interaction with the aging display mechanism and to obtain from the aging display mechanism generator a modified aging display mechanism.

12. The computing system of claim 11 wherein the data aggregation component is configured to re-aggregate the aged data based on the modified aging period definition and display the re-aggregated data along with the modified aging display mechanism.

13. A computing system, comprising:
an aging display mechanism generator configured to generate an aging display mechanism based on an aging period definition, the aging display mechanism having a timeline and user actuatable interval slider mechanisms displayed at boundaries between aging intervals on the timeline, the aging intervals representing intervals of aged data, the interval slider mechanisms being configured to be actuated to move along the timeline based on a slider user input; and
a slider interaction processing system configured to modify the aging intervals, in the aging period definition, on opposite sides of a given interval slider mechanism based on movement of the given interval slider mechanism along the timeline.

14. The computing system of claim 13 and further comprising:
a data aggregation component configured to access the aged data and the aging period definition and aggregate the aged data based on the aging intervals in the aging period definition, and display the aged data aggregated in the aging intervals.

15. The computing system of claim 14 and further comprising:
a runtime interaction engine configured to display the aging display mechanism along with the aged data.

16. The computing system of claim 15 wherein the run time interaction engine is configured to modify the aging period definition, to obtain a modified aging period definition based on runtime interaction with the aging display mechanism and to obtain from the aging display mechanism generator a modified aging display mechanism.

17. The computing system of claim 16 wherein the data aggregation component is configured to re-aggregate the aged data based on the modified aging period definition and display the re-aggregated data along with the modified aging display mechanism.

18. The computing system of claim 17 and further comprising:
an aging period definition component that displays an aging period configuration user input mechanism configured to receive an interval configuration user input and configure the aging period definition with the aging intervals based on the interval configuration user input.

19. A computer readable storage medium storing computer readable instructions which, when executed by a computer, cause the computer to perform a method, comprising:
displaying an aging display mechanism based on an aging period definition, the aging display mechanism having a timeline and user actuatable interval slider mechanisms displayed at boundaries between aging intervals on the timeline, the aging intervals representing intervals of aged data;
aggregating the aged data based on the aging intervals in the aging period definition;
displaying the aged data aggregated in the aging intervals, along with the aging display mechanism;
receiving user actuation of a given interval slider mechanism;
visually moving the given interval slider mechanism along the timeline of the aging display mechanism based on the user actuation;
modifying the aging intervals, in the aging period definition, on opposite sides of the given interval slider mechanism based on the movement of the given interval slider mechanism along the timeline;
re-aggregating the aged data based on the modified aging intervals; and
displaying the re-aggregated aged data.

20. The computer readable storage medium of claim 19 and further comprising:
displaying an aging period configuration user input mechanism;
receiving an interval configuration user input; and
configuring the aging period definition with the aging intervals based on the interval configuration user input.
